(19) United States
(12) Patent Application Publication
(10) Pub. No.: US 2025/0146152 A1
(43) Pub. Date: May 8, 2025

(54) PROCESS FOR DIRECT CONVERSION OF FLUE GAS IN LOW-CARBON FUELS AND IRON-BASED CATALYSTS TO CARRY OUT SAME

(71) Applicant: SOCPRA SCIENCES ET GENIE S.E.C., Sherbrooke (CA)

(72) Inventors: Jean-Michel LAVOIE, Milan (CA); Bruna REGO DE VASCONCELOS, Sherbrooke (CA); Fabio GONCALVES MACEDO DE MEDEIROS, Natal (BR)

(21) Appl. No.: 18/707,675

(22) PCT Filed: Nov. 7, 2022
(86) PCT No.: PCT/CA2022/051644

§ 371 Date: May 6, 2024

Related U.S. Application Data
(60) Provisional application No. 63/263,592, filed on Nov. 5, 2021.

(51) Int. Cl. C25B 11/091; B01D 53/32; B01D 53/86; C25B 1/23

(52) U.S. Cl. CPC C25B 11/091; B01D 53/32; B01D 53/8609; B01D 53/8671; C25B 1/23; B01D 2255/20738; B01D 2255/9202; B01D 2255/9205; B01D 2257/302; B01D 2257/504; B01D 2258/0283

(57) ABSTRACT

There is provided a process for converting a CO₂ and/or H₂O-containing gas mixture, such as flue gas, into a low-carbon fuel. The process comprises contacting the gas mixture with a catalyst comprising: a catalyst body having metallic iron exposed superficially and pores. There is also provided processes for manufacturing an iron-based porous catalyst as porous monoliths having exposed catalytically active surfaces. There is also provided an iron-based catalyst, including iron oxides, to at least partially remove SOₓ from a gas mixture and a process for at least partially removing SOₓ from a gas mixture using the iron-based catalyst.

### CROSS-REFERENCE TO RELATED APPLICATIONS

This application claims priority under 35USC § 119 (e) of U.S. provisional patent application 63/263,592 filed on Nov. 5, 2021, the specification of which is hereby incorporated by reference.

### TECHNICAL FIELD OF THE INVENTION

The technical field relates to a conversion process wherein CO₂ and H₂O mixtures, such as flue gases, are converted into low-carbon fuels, such as syngas. It also relates to a metallic iron-based catalyst to carry out the flue gas conversion process, to an iron-based catalyst including iron oxides for at least partial removal of SOₓ and to processes for manufacturing the metallic iron-based catalyst. It further relates to a continuous reactor to perform the flue gas conversion process.

### BACKGROUND

Most of the energy currently produced is based on fossil fuels. Flue gas, a direct product of fossil fuel combustion, is a significant source of greenhouse gas (GHG) emissions from different sectors, such as transportation and industrial sectors. As primary combustion products, CO₂ and H₂O are the main components of flue gas, which can also include of O₂, N₂, CO, NOₓ, SOₓ, particulate matter, and volatile organic compounds (VOC) at different levels depending on the quality of the combustion process and the fuel type. Table 1, below, presents a general composition of flue gas, obtained from the combustion of different fuels.

TABLE 1
Composition of different flue gas mixtures.

| | CO₂ | H₂O | O₂ | N₂ | CO | NOₓ | SO₂ | PM | VOC |
|---|---|---|---|---|---|---|---|---|---|
| | (% vol.) | (% vol.) | (% vol.) | (% vol.) | (ppm) | (ppm) | (ppm) | (ppm) | (ppm) |
| NG | 3-14 | 7-29 | 1-15 | 54-80 | 0-5 | 50-147 | — | — | — |
| Coal | 5-15 | 5-15 | 2-13 | 65-80 | 0-100 | 1-1500 | 3-1800 | 10-120 | 180 |
| Diesel | 5-8 | 1-14 | 4-10 | 73-78 | 323-450 | 70-600 | 9-30 | — | 282 |
| Gasoline | 5-12 | 3-5 | 0-8 | 74-77 | 1-10 | 100-500 | 0-20 | — | 100 |

Legend: NG—Natural gas; PM—Particulate matter; VOC—Volatile organic compounds.
Sources: Legrand, U., Apfel, U. P., Boffito, D. C., & Tavares, J. R. (2020).
The effect of flue gas contaminants on the CO₂ electroreduction to formic acid.
Journal of CO₂ Utilization, 42(August), 101315; Sassykova, L. R., Aubakirov, Y. A., Sendilvelan, S., Tashmukhambetova, Z. K., Faizullaeva, M. F., Bhaskar, K., Batyrbayeva, A. A., Ryskaliyeva, R. G., Tyussyupova, B. B., Zhakupova, A. A., & Sarybayev, M. A. (2019).
The Main Components of Vehicle Exhaust Gases and Their Effective Catalytic Neutralization.
Oriental Journal of Chemistry, 35(1), 110-127.

Hydrocarbon-reforming technologies, especially steam reforming of methane (SRM), are still the most practiced technologies for syngas production at industrial scale. Recently, Power-to-X (PtX) technologies, which convert CO₂, H₂O using renewable electricity, have been widely investigated as an alternative environmental-friendly pathway to produce low-carbon energy vectors, such as syngas, methane, methanol, diesel etc.

Flue gas emissions are a major source of CO₂ and the development of technologies for its utilization is of utmost industrial interest. However, classical PtX processes (CO₂ hydrogenation and electrochemical reduction) still face techno-economic challenges for implementation, mainly related to the capital and operational costs (CAPEX and OPEX) of hydrogen production via water electrolysis and the CO₂ purification steps, as well as high material costs and low products selectivity (Brynolf, S., Taljegard, M., Grahn, M., & Hansson, J. (2018). Electrofuels for the transport sector: A review of production costs. Renewable and Sustainable Energy Reviews, 81, 1887-1905; Garg, S., Li, M., Weber, A. Z., Ge, L., Li, L., Rudolph, V., Wang, G., & Rufford, T. E. (2020). Advances and challenges in electrochemical CO₂ reduction processes: An engineering and design perspective looking beyond new catalyst materials. Journal of Materials Chemistry A, 8(4), 1511-1544).

In view of the above, there is a need for a new conversion process for flue gas and a catalyst to carry out same which would be able to overcome or at least minimize some of the above-discussed prior art concerns.

### BRIEF SUMMARY OF THE INVENTION

It is therefore an aim of the present invention to address the above-mentioned issues.

According to a general aspect, there is provided a catalyst comprising: a catalyst body having metallic iron exposed superficially and pores. In an embodiment, the catalyst body comprises a bed of iron-based pieces with gas flow channels being defined between the iron-based pieces. In another embodiment, the catalyst body comprises steel wool. In still another embodiment, the catalyst body comprises a porous structured metallic iron-based body with metallic iron being exposed superficially.

In an embodiment, the catalyst body comprises at least one catalyst promoter exposed superficially and the at least one catalyst promoter is selected from the group consisting of potassium (K), cobalt (Co), CaO, copper (Cu), nickel (Ni), CeO₂, and mixtures thereof.

According to another general aspect, there is provided a process for manufacturing a metallic iron-based porous catalyst, comprising:
a. Providing a porous structure made from a material having a decomposition temperature lower than a sintering temperature for metallic iron.
b. Coating the porous structure with metallic iron particles;
c. Heating the porous structure coated with metallic iron particles to a temperature higher than the decomposition temperature; and
d. Increasing the temperature to sintering the metallic iron particles to form a sintered metallic iron-based catalyst.

In an embodiment, the porous structure is polymeric, such as a polymeric foam which can be selected from the group consisting of: a polyurethane foam, a polyethylene foam, and polystyrene.

In an embodiment, coating the porous structure with iron particles comprises soaking the polymer foam in a binder solution containing iron powder. The binder solution can comprise at least one of sodium alginate, carboxymethyl cellulose, hydroxypropyl cellulose, stearic acid, polyvinyl butyral, and polyvinyl alcohol. The process can further comprise drying the soaked polymer foam before the sintering.

The process can further comprise impregnating the sintered metallic iron-based catalyst with at least one catalyst promoter. The at least one catalyst promoter can be selected from the group consisting of potassium (K), cobalt (Co), CaO, copper (Cu), nickel (Ni), CeO₂, and mixtures thereof.

The process can further comprise impregnating the sintered metallic iron-based catalyst with at least one catalyst promoter comprises carrying out one of incipient wetness impregnation and wet impregnation of the at least one catalyst promoter.

According to still another general aspect, there is provided a process for converting a gas mixture into a low-carbon fuel. The process comprises:
a. providing a gas mixture including CO₂ and H₂O; and
b. contacting the gas mixture with the catalyst as detailed above at a reaction temperature ranging between about 500° C. and about 950° C. to produce reaction products including at least a mixture of H₂ and CO.

In an embodiment, the gas mixture comprises flue gas.

In an embodiment, the gas mixture comprises untreated flue gas including at least one of O₂, N₂, CO, NOₓ, SOₓ, particulate matter, and volatile organic compounds (VOC).

In an embodiment, the process further comprises applying an electrical current to the catalyst when contacted by the gas mixture.

In an embodiment, the gas mixture is contacted with the catalyst at atmospheric pressure.

According to a further general aspect, there is provided an iron-based catalyst to at least partially remove SOₓ from a gas mixture, the catalyst including iron oxides. The iron oxides can comprise Fe₂O₃.

In an embodiment, the iron oxides were formed during a conversion reaction wherein a gas mixture including CO₂ and H₂O was converted into a low-carbon fuel including at least a mixture of H₂ and CO.

In an embodiment, the catalyst is porous.

In an embodiment, the gas mixture including SOₓ further comprises CO₂ and H₂O.

According to another general aspect, there is provided a process for at least partially removing SOₓ from a gas mixture. The process comprises: providing a gas mixture including CO₂ and H₂O; and contacting the gas mixture with the iron-based catalyst including iron oxides as described above.

According to still another general aspect, there is provided a continuous reactor comprising: a housing defining a reaction chamber configured to contain a metallic iron-based porous catalyst, as described above, the housing having a flue gas inlet and a reaction product outlet and being configured to have a continuous flow gas flowing in the reaction chamber between the flue gas inlet and the reaction product outlet. In an embodiment, the continuous reactor further comprises the iron-based catalyst including iron oxides, as described above.

According to a general aspect, there is provided a H₂O and CO₂ conversion catalyst comprising: a catalyst body comprising at least 50 wt % of iron and having a plurality of gas flow channels extending therethrough thereby defining exposed catalytically-active surfaces comprising metallic iron.

In an embodiment, the catalyst body comprises a bed of iron-based pieces with the gas flow channels being defined between the iron-based pieces. The iron-based pieces can have a size ranging from about 0.01 cm to about 0.7 cm.

In an embodiment, the catalyst body comprises steel wool.

In an embodiment, the catalyst body comprises a porous metallic iron-based monolith.

In an embodiment, the catalyst body comprises between about 40 and about 55 wt % of metallic iron.

In an embodiment, the catalyst body has a volume and at least 25% of the volume is defined by the gas flow channels. The gas flow channels can comprise pores defined through the catalyst body and the catalyst body can have a pore volume of at least 0.10 cm³/g. The catalyst body can have a porosity above 25%.

In an embodiment, at least 95% of the exposed catalytically-active surfaces comprise iron.

In an embodiment, the exposed catalytically-active surfaces comprise at least 50% of metallic iron.

In an embodiment, the catalyst body is a monolith produced by sintering a loose iron-based powder.

In an embodiment, the catalyst body is a monolith obtained by sintering a coating comprising iron, the coating being deposited onto a degradable porous 3D structure.

In an embodiment, the H₂O and CO₂ conversion catalyst further comprises at least one catalyst promoter being exposed superficially on the catalyst body, and wherein the at least one catalyst promoter is selected from the group consisting of potassium (K), cobalt (Co), CaO, copper (Cu), nickel (Ni), CeO₂, and mixtures thereof.

According to another general aspect, there is provided a process for manufacturing a monolithic iron-based catalyst. The process comprises:

Providing a porous structure made from a material having a decomposition temperature lower than a sintering temperature for metallic iron.

Coating the porous structure with metallic iron particles;

Heating the porous structure coated with metallic iron particles to a temperature higher than the decomposition temperature of the porous structure; and Increasing the temperature to at least the sintering temperature for metallic iron to sinter the metallic iron particles and form a sintered iron-based catalyst body.

In an embodiment, the porous structure is polymeric.

In an embodiment, the porous structure comprises a polymeric foam, which can be selected from the group consisting of: a polyurethane foam, a polyethylene foam, and polystyrene.

In an embodiment, coating the porous structure with the metallic iron particles comprises soaking the porous structure in a binder solution containing the metallic iron particles. The metallic iron particles can have a particle size distribution between about 15 nm and about 212 μm. The binder solution can further comprise at least one of sodium alginate, carboxymethyl cellulose, hydroxypropyl cellulose, stearic acid, polyvinyl butyral, and polyvinyl alcohol. In an embodiment, the process further comprises drying the soaked porous structure before the sintering, which can be performed for at least 5 hours at a temperature above about 100° C.

In an embodiment, the process further comprises impregnating the sintered iron-based catalyst body with at least one catalyst promoter, which can be selected from the group consisting of potassium (K), cobalt (Co), CaO, copper (Cu), nickel (Ni), CeO₂, and mixtures thereof. It can be carryied out one of incipient wetness impregnation and wet impregnation of the at least one catalyst promoter.

In an embodiment, the porous structure coated with metallic iron particles is heated to a temperature below about 500° C.

In an embodiment, the metallic iron particles are sintered at a sintering temperature above 900° C.

According to still another general aspect, there is provided a process for manufacturing a monolithic iron-based catalyst. The process comprises:
Filling a mold cavity with loose iron-based powder containing at least 50 wt % of metallic iron; and
Heating the loose iron-based powder contained in the mold cavity to a sintering temperature above about 900° C. to form a sintered iron-based catalyst body.

In an embodiment, filling the mold cavity with the loose iron-based powder comprises at least one of pouring and vibrating without compressing the iron-based powder contained in the mold cavity.

In an embodiment, the loose iron-based powder contained in the mold cavity is binder free.

In an embodiment, the loose iron-based powder comprises particles smaller than about 200 mesh.

In an embodiment, the process further comprises impregnating the sintered iron-based catalyst body with at least one catalyst promoter, which can be carried out one of incipient wetness impregnation and wet impregnation of the at least one catalyst promoter. The at least one catalyst promoter can be selected from the group consisting of potassium (K), cobalt (Co), CaO, copper (Cu), nickel (Ni), CeO₂, and mixtures thereof.

In an embodiment, the loose iron-based powder comprises at least 95 wt % of metallic iron particles.

In an embodiment, the loose iron-based powder consists essentially of metallic iron particles, except for unavoidable impurities.

According to still a further general aspect, there is provided a process for converting a gas mixture into a low-carbon fuel, the process comprising:
providing a feed gas mixture including CO₂ and H₂O; and
contacting the feed gas mixture with the CO₂ and H₂O conversion catalyst as defined in any one of claims 1 to 14 at a reaction temperature ranging between about 400° C. and about 950° C. to produce a product mixture including H₂ and CO.

In an embodiment, the feed gas mixture comprises flue gas.

In an embodiment, the feed gas mixture comprises untreated flue gas including at least one of O₂, N₂, CO, NOₓ, SOₓ, particulate matter, and volatile organic compounds (VOC). The untreated flue gas can comprise at least 50 ppm of a total content of NOₓ, SOₓ, particulate matter, and volatile organic compounds (VOC).

In an embodiment, the process further comprises applying an electrical current to the H₂O and CO₂ conversion catalyst when contacted by the feed gas mixture. The electrical current can be between about 5 Å and about 300 A and an electrical power can be between about 10 W and 2200 W.

In an embodiment, the feed gas mixture is contacted with the H₂O and CO₂ conversion catalyst at atmospheric pressure.

In an embodiment, the feed gas mixture is contacted with the H₂O and CO₂ conversion catalyst in pressurized conditions up to 100 bar.

In an embodiment, the product mixture has a ratio H₂/CO between about 0 and about 3.0.

In an embodiment, the feed gas mixture has a ratio H₂O/CO₂ ranging from about 0.05 to about 3.0 and, in another embodiment, the feed gas mixture has a ratio H₂O/CO₂ ranging from about 0.3 to about 2.0.

In an embodiment, the feed gas mixture comprises a reducing gas, which can comprise a portion of the product mixture.

In an embodiment, the reaction temperature ranges between about 500° C. and about 900° C.

According to still another general aspect, there is provided an iron-based catalyst for at least partially removing SOₓ from a gas mixture. The iron-based catalyst comprises a catalyst body including at least one iron oxide.

In an embodiment, the at least one iron oxide comprises FeO, Fe₂O₃, Fe₃O₄, or any combinations thereof.

The iron-based catalyst, being an at least partially deactivated iron-based resulting from deactivation of an active iron-based catalyst, wherein the at least one iron oxide can be formed during a conversion reaction wherein a gas mixture including CO₂ and H₂O is converted into a low-carbon fuel including at least a mixture of H₂ and CO using the active iron-based catalyst.

Still according to another general aspect, there is provided the iron-based catalyst as described above, wherein the active iron-based catalyst as described above, or as produced by the process as described above.

In an embodiment, the catalyst body is porous. For instance, it has a pore volume of at least 0.25 cm³/g.

In an embodiment, the gas mixture including SOₓ further comprises CO₂ and H₂O.

Still according to another general aspect, there is provided a process for at least partially removing SOₓ from a gas mixture. The process comprises:
providing a feed gas mixture including CO₂, H₂O, and SOₓ; and
contacting the feed gas mixture with a catalytic medium comprising the iron-based catalyst as described above.

In an embodiment, contacting the feed gas mixture with the iron-based catalyst is carried out at a reaction temperature ranging between about 400° C. and about 950° C. to produce a product mixture including H₂ and CO.

In an embodiment, the feed gas mixture comprises flue gas.

In an embodiment, the feed gas mixture comprises untreated flue gas including at least one of O₂, N₂, CO, NOₓ, particulate matter, and volatile organic compounds (VOC).

In an embodiment, the process further comprises applying an electrical current to the iron-based catalyst when contacted by the feed gas mixture. For instance, the electrical current can be between about 5 A and about 300 A and an electrical power can be between about 10 W and 2200 W.

In an embodiment, the feed gas mixture is contacted with the iron-based catalyst at atmospheric pressure.

In an embodiment, the feed gas mixture is contacted with the iron-based catalyst in pressurized conditions up to 100 bar.

In an embodiment, the product mixture has a ratio H₂/CO between about 0 and about 3.0.

In an embodiment, the feed gas mixture has a ratio H₂O/CO₂ ranging from about 0.05 to about 3.0 and, in another embodiment, the feed gas mixture has a ratio H₂O/CO₂ ranging from about 0.3 to about 2.0.

In an embodiment, the reaction temperature ranges between about 500° C. and about 900° C.

In an embodiment, the catalytic medium further comprises the catalyst as described above, or as produced by the process as described above.

According to another general aspect, there is provided a continuous reactor comprising: a housing defining a reaction chamber configured to contain the CO₂ and H₂O conversion catalyst as described above, the housing having a feed gas inlet and a reaction product outlet and being configured to have a continuous flow gas flowing in the reaction chamber between the feed gas inlet and the reaction product outlet.

In this specification, the term “catalytic medium” is intended to include at least the conversion reaction catalyst, which can be iron-based or, more specifically, metallic iron-based or, still can include a mixture of metallic iron (Fe) and iron oxides (FeO, Fe₂O₃, and/or Fe₃O₄), but can include other chemical components/species including other catalysts for additional reactions, for instance to treat other components of a flue gas.

In this specification, the term “iron-based catalyst” is intended to include a catalyst having iron as major constituent, without compulsorily exceeding 50 wt %. It can include iron oxides (FeO, Fe₂O₃, and/or Fe₃O₄), metallic iron (Fe), other chemical components/species including other catalysts for additional reactions, and mixtures thereof.

In this specification, the term “metallic iron-based catalyst” is intended to include a catalyst having iron as major constituent, without compulsorily exceeding 50 wt %. It can include iron oxides (FeO, Fe₂O₃, and/or Fe₃O₄), other chemical components/species including other catalysts for additional reactions, and mixtures thereof.

In this specification, the term “exposed superficially” refers to the chemical species, such as iron, exposed in the most external layer of the catalyst. It is appreciated that the chemical species, such as iron, can be present both in the surface (i.e. superficially exposed) and in the bulk of the catalyst structure.

In this specification, the terms “gas flow channel” and “pore” refer to the void fraction of a catalyst body. The catalyst body can be single piece or can including a plurality of pieces.

The present document refers to a number of documents, the contents of which are hereby incorporated by reference in their entirety.

### BRIEF DESCRIPTION OF THE DRAWINGS

FIG. 1 is a photograph of a metallic iron-based porous catalyst in accordance with a first embodiment, wherein the iron-based catalyst includes steel wool.

FIG. 2 is a photograph of the metallic iron-based porous catalyst in accordance with a second embodiment, wherein the metallic iron-based catalyst includes a porous structured catalyst.

FIG. 3 is a schematic flowchart showing a process to manufacture the metallic iron-based porous structured catalyst of FIG. 2.

FIG. 4A is a photograph of metallic iron-based green compacts contained in a quartz insulation mold for the synthesis of metallic iron-based catalysts via a loose powder sintering method and FIG. 4B is a photograph of a sintered metallic iron-based catalyst produced by the loose powder sintering method.

FIG. 5 includes FIG. 5A and FIG. 5B and refers to tests for the conversion of CO₂ and H₂O in the presence of the steel wool catalyst of FIG. 1 (GHSV (gas hourly space velocity)=126 h⁻¹) for tests carried without electricity, i.e. without electric current applied to the catalyst; FIG. 5A is a graph showing the CO₂ (∘) and H₂O (□) conversions over the steel wool catalyst of FIG. 1 as a function of a reaction temperature; FIG. 5B is a graph showing the CO (Δ) and H₂ (⋄) selectivity and H₂/CO ratio (∘) over the steel wool catalyst of FIG. 1 as a function of a reaction temperature.

FIG. 6 includes FIG. 6A and FIG. 6B and refers to tests for the conversion of CO₂ and H₂O (GHSV=126 h⁻¹) for tests carried electric current (P=300 W, I=100 A) being applied directly through a catalytic medium including the steel wool catalyst of FIG. 1; FIG. 6A is a graph showing the CO₂ (∘) and H₂O (□) conversions as a function of time;

FIG. 6B is a graph showing the CO (∘) and H₂ (□) selectivity and H₂/CO ratio (⋄) as a function of time.

FIG. 7 includes FIG. 7A, FIG. 7B, FIG. 7C, FIG. 7D, FIG. 7E, and FIG. 7F; FIGS. 7A and 7D are graphs showing the carbon balance. FIGS. 7B and 7E are graphs showing the hydrogen balance, FIGS. 7C and 7F are graphs showing the oxygen balance., FIGS. 7A, FIG. 7B, and FIG. 7C refer to tests carried out with the metallic iron catalyst shown in FIG. 1 and without electricity applied to the catalytic medium while FIGS. 7D, FIG. 7E, and FIG. 7F refer to tests carried with the metallic iron catalyst shown in FIG. 1 and with electricity applied directly to the catalytic medium.

FIG. 8 includes FIG. 8A, FIG. 8B, FIG. 8C, and FIG. 8D and are XRD patterns of the steel wool catalyst (FIG. 1). FIG. 8A is the XRD pattern of the steel wool catalyst before the conversion reaction, and FIGS. 8B, 8C, and 8D are the XRD patterns of the steel wool catalyst after 3 hours, 9 hours and 20 hours of the conversion reaction with CO₂ and H₂O, as reactants, respectively, at a reaction temperature of 700° C. and with an electrical current of 100 A (P=300 W) applied to the catalyst.

FIG. 9 includes FIG. 9A and FIG. 9B and refers to tests for the conversion of a simulated flue gas in the presence of the porous structured metallic iron catalyst shown in FIG. 2 (I=100 A, P=300 W, GHSV=310 h⁻¹); FIG. 9A is a graph showing the CO₂ (∘) and H₂O (□) conversions as a function of the reaction temperature; FIG. 9B is a graph showing the CO (∘) and H₂ (□) selectivity and H₂/CO ratio (⋄) as a function of the reaction temperature.

FIG. 10 includes FIG. 10A and FIG. 10B and refers to tests for the conversion of a simulated flue gas in the presence of the porous structured metallic iron catalyst shown in FIG. 2 (I=100 A, P=300 W, GHSV=310 h⁻¹); FIG. 10A is a graph showing the CO₂ (∘) and H₂O (□) conversions as a function of the reaction temperature with electricity applied to the catalytic medium including the catalyst; FIG. 10B is a graph showing the CO (∘) and H₂ (u) selectivity and H₂/CO ratio (⋄) as a function of the reaction temperature, with electricity applied to the catalytic medium including the catalyst.

FIG. 11 includes FIG. 11A, FIG. 11B, FIG. 11C, FIG. 11D, FIG. 11E, and FIG. 11F; FIGS. 11A and 11D show the carbon balance as a function of the reaction temperature for the conversion of a simulated flue gas, FIGS. 11B and 11E show the hydrogen balance as a function of the reaction temperature for the conversion of a simulated flue gas, FIGS. 11C and 11F show the oxygen balance as a function of the reaction temperature for the conversion of a simulated flue gas. FIGS. 11A, FIG. 11B, and FIG. 11C were carried out without electricity while FIGS. 11D, FIG. 11E, and FIG. 11F were carried out with electricity (P=300 W; I=100 A) applied to the catalytic medium including the porous structured metallic iron-based catalyst shown in FIG. 2.

FIG. 12 includes FIG. 12A and FIG. 12B and refers to tests for the conversion of an untreated real flue gas stream in the presence of a non-promoted porous structured metallic iron-based catalyst shown in FIG. 2 for a reaction temperature of T=700° C. and a GHSV=310 h⁻¹; FIG. 12A is a graph showing the CO₂ (∘) and H₂O (□) conversions as a function of the reaction time; FIG. 12B is a graph showing the CO (∘) and H₂ (a) selectivity and SO₂ (⋄) and NOₓ (Δ) contents at the outlet stream as a function of the reaction time.

FIG. 13 is a graph showing the CO₂, H₂O, SO₂, and NOₓ conversions, CO₂ and H₂ selectivity and H₂/CO ratio as a function of the reaction time for the conversion of an untreated flue gas stream in the presence of K-promoted sintered metallic iron-based catalyst produced by the loose powder sintered method, at a reaction temperature of 700° C. and a GHSV=310 h⁻¹, during the reaction the H₂O/CO₂ ratio of the flue gas stream was modified from 0.3-0.32 to 2.0.

FIG. 14 includes FIGS. 14A, 14B, and 14C and refers to tests for the conversion an untreated flue gas stream carried out at lab scale in the presence of a 5 wt % K-promoted sintered metallic iron-based catalyst as shown in FIG. 4B and with electricity (P=10 W; I=5 A), at a reaction temperature of T=700° C., total gas flow rate (Qₜ)=25 mL/min, and a GHSV=157 h⁻¹; FIG. 14A is a graph showing the CO₂ and H₂O conversions a function of the reaction time; FIG. 14B is a graph showing the CO₂ and H₂ selectivity and H₂/CO ratio as a function of the reaction time; and FIG. 14C is a graph showing the SO₂ and NOₓ conversions as a function of the reaction time.

FIG. 15 includes FIGS. 15A, 15B, and 15C and refers to tests for the conversion an untreated flue gas stream carried out in a semi-pilot reactor in the presence of a 5 wt % K-promoted sintered metallic iron-based catalyst shown in FIG. 4B and without electricity, at a reaction temperature of T=700° C., Qₜ=560 mL/min, and a GHSV=157 h 1; FIG. 15A is a graph showing the CO₂ (∘) and H₂O (□) conversions as a function of the reaction time; FIG. 15B is a graph showing the CO (∘) and H₂ (u) selectivity and H₂/CO ratio contents at the outlet stream as a function of the reaction time; and FIG. 15C is a graph showing the SO₂ (∘) and NOₓ (□) conversion at the outlet stream as a function of the reaction time.

FIG. 16 includes FIGS. 16A and 16B; FIG. 16A are XRD patterns for the sintered Fe₂O₃ after sintering and prior to activation; FIG. 16B is a graph showing the flue gas conversion of the flue gas over sintered Fe₂O₃ catalysts for a reaction temperature of T=700° C., a ratio H₂O/CO₂=0.05, and a GHSV=310 h⁻¹. For FIG. 16B, the conversion of CO₂ (∘) and H₂O (□) is shown with the selectivity towards syngas (CO (Δ) and H₂ (⋄)) and the concentrations (ppm) of NOₓ (▪) and SO₂ ([ [symbol] ]) at the outlet stream as a function of the reaction time.

FIG. 17 includes FIG. 17A and FIG. 17B and refers to tests for the conversion of an untreated real flue gas stream in the presence of the K-promoted porous structured metallic iron-based catalyst shown in FIG. 2 for a reaction temperature of T=700° C. and a GHSV=310 h⁻¹; FIG. 17A is a graph showing the CO₂ (∘) and H₂O (□) conversions as a function of the reaction time; FIG. 17B is a graph showing the CO (∘) and H₂ (□) selectivity and SO₂ (⋄) and NOₓ (Δ) contents at the outlet stream as a function of the reaction time.

FIG. 18 includes FIG. 18A, FIG. 18B, FIG. 18C, FIG. 18D, FIG. 18E, and FIG. 18F; FIGS. 18A and 18D show the carbon balance as a function of the reaction time for the conversion of an untreated real flue gas stream for a reaction temperature of T=700° C. and a GHSV=310 h⁻¹, FIGS. 18B and 18E show the hydrogen balance as a function of the reaction time for the conversion of an untreated real flue gas stream, FIGS. 18C and 18F show the oxygen balance as a function of the reaction time for the conversion of an untreated real flue gas stream, FIGS. 18A, FIG. 18B, and FIG. 18C were carried out with the non-promoted porous structured metallic iron-based catalyst while FIGS. 18D, FIG. 18D, and FIG. 18F were carried out with the K-promoted porous structured metallic iron-based catalyst of FIG. 2.

FIG. 19 includes FIG. 19A and FIG. 19B; FIGS. 19A and 19B are graphs showing the influence of pressure (from 1 to 100 bar) over H₂ and CO production, respectively, from flue gas with different H₂O/CO₂ ratio (ranging from 0.3 to 3.0) at 700° C. for (GHSV=310 h⁻¹).

FIG. 20 includes FIG. 20A and FIG. 20B; FIGS. 20A and 20B are graphs showing the influence of temperature (from 200° C. to 900° C.) over H₂ and CO production, respectively, from flue gas with different H₂O/CO₂ ratio (ranging from 0.3 to 3.0) at 1 bar for (GHSV=310 h⁻¹).

FIG. 21 is a graph showing an estimated increase in the catalyst lifespan for different H₂/CO₂ ratios in the inlet feed.

FIG. 22 graph showing an estimated increase in the catalyst lifespan, as a reducing agent, for different H₂/CO₂ ratios in the inlet feed and with a fixed reducing agent-to-CO₂ ratio of 1.0.

FIG. 23 is a schematic representation of a system including a continuous reactor to carry out the conversion process on flue gas.

It will be noted that throughout the appended drawings, like features are identified by like reference numerals.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value. For instance, it is commonly accepted that a 10% precision measure is acceptable and encompasses the term “about”.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element. It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs. The present invention may be implemented in the testing or practice with methods and materials equivalent or similar to those described herein.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined.

In accordance with an embodiment, there is provided a process for the production of low-carbon fuels, such as syngas, which is a mixture comprising hydrogen (H₂) and carbon monoxide (CO), from a gaseous reactant composition including carbon dioxide (CO₂) and water (H₂O), which can be a flue gas, using an iron-based catalyst. In an embodiment, the iron-based catalyst comprises at least 50 wt % of iron and, in an embodiment, at least 80 wt % of iron, when the iron-based catalyst is in a pre-conversion reaction state. The pre-conversion reaction state of the catalyst is intended to refer to a state of the catalyst when introduced in the conversion reactor and before fulfilling a catalytic function for the conversion reaction. In an embodiment, to be active and thus have a catalytic function during the conversion reaction of CO₂ and H₂O into syngas, the iron of the iron-based catalyst is mostly non-oxidized iron and, more particularly, metallic iron. More particularly, metallic iron is the most active phase for the conversion reaction and the component having the highest concentration in the catalyst. In some embodiments, the iron-based catalyst is a metallic iron-based catalyst including metallic iron (Fe) as major constituent, i.e. the component with the highest concentration, without compulsorily exceeding 50 wt %. In other embodiments, the metallic iron content in the catalyst composition is about 50 wt %. In addition to the metallic iron, the catalyst composition can include catalyst promoters (as further defined herein) and/or iron oxides (such as FeO, Fe₂O₃, Fe₃O₄). As detailed below, it should however be understood that the catalyst composition varies during the conversion reaction, and unless mention to the contrary, the composition and properties of the catalyst are given for the pre-conversion reaction state.

The iron-based catalyst is a porous structured catalyst, and is provided as a metallic catalyst body that can have several configurations to confer a high porosity and therefore a high catalytically-active surface area to the resulting catalyst or catalytic medium. The catalyst body can for example be a porous monolith, steel wool (or steel wire filaments), or a bed of stacked iron-based pieces/particles. In the specification, steel wool is intended to mean a bundle of very fine and flexible sharp-edged steel filaments and is also known as iron wool, wire wool, steel wire or wire sponge. In the specification, the iron-based pieces have a size ranging from about 0.01 cm to about 0.7 cm, in another 0.015 cm to about 0.35 cm and, in an embodiment, from about 0.018 cm to about 0.32 cm.

The configuration of the catalyst body thus determines a flow pattern of the reactants and products, for example by defining gas flow channels extending therethrough. For example, the gas flow channels can be defined by the interconnected void fractions existing between the iron-based pieces of the bed, between the filaments of the steel wool or inside the pores of the porous monolith. The multiple gas flow channels can be referred to as a network of gas flow channels along which gaseous reactants are exposed to a portion of the surface of the catalyst, such portion being defined as a catalytically-active surface or exposed catalytic surface(s). The metallic catalyst body as encompassed herein is selected to maximize the catalytically-active surface(s).

Thus, the catalyst body is defined by a high catalytically-active surface area. In an embodiment, the apparent density of the iron-based catalyst is at least 0.25 g/cm³. In an embodiment, the apparent density of the iron-based catalyst is less than about 4 g/cm³. The catalyst body has a volume, including the gas flow channels (or pores), and, in an embodiment, at least 25% of this volume is defined by the gas flow channels. In another embodiment, at least 50% of this volume is defined by the gas flow channels.

During the reforming reaction, the metallic iron (Fe) of the iron-based catalyst is initially oxidized by water and CO₂, from the gaseous reactants, to Fe₃O₄ through reactions 1, 2 or 3, which results in the production of low-carbon fuel (syngas including H₂ and CO).

3Fe+4CO₂→Fe₃O₄+4CO (1)

3Fe+4H₂O⇄Fe₃O₄+4H₂ (2)

CO₂+3H₂O+3Fe→CO+3H₂+Fe₃O₄ (3)

In an embodiment, the ratio hydrogen to carbon monoxide (H₂/CO) in the reaction product (or product mixture) can be varied by adjusting/controlling operational conditions of the conversion reaction, including a feed composition of the reactant mixture (such as a H₂O/CO₂ ratio) and/or the reaction temperature. Syngas with tunable H₂/CO ratio varying between 0 and 3.0 can be produced. For instance and without being limitative, the feed gas mixture, such a feed gas mixture including flue gas, can have a H₂O/CO₂ ratio around 0, which would produce a syngas free of H₂ (H₂/CO=0). For a feed gas mixture having have a H₂O/CO₂ ratio in a range of 0.3 to 2.5, syngas with H₂/CO ratios in the range of 0.4 to 3.0 were produced. For higher H₂O/CO₂ ratio (i.e. >2.5), syngas with higher H₂/CO ratios can be produced (i.e. >3.0). For example, the feed composition can be modified by adding water and, more particularly, gaseous water, to the chemical reaction intrants, such as flue gas. For example, the reaction temperature can be between about 400° C. and about 950° C.

Hence, the conversion process is versatile since the low-carbon fuel composition can be modified to comply with the requirements of a downstream process and the final energy vector desired (methanol, methane, diesel, jet fuel, gasoline, formic acid etc). Thus, the process allows the direct conversion of abundant industrial emissions (flue gas), including CO₂ and H₂O, into syngas, i.e. a value-added product with several potential applications and a significant energetic value. For instance, the product of the conversion reaction, such as syngas, can be used in downstream process for the production of other energy vectors such as and without being limitative, methanol, methane, diesel, etc.

In an embodiment, the reactant (reaction intrant, feedstock or feed) of the direct conversion reaction is a chemically untreated flue gas (mainly composed of CO₂, H₂O, N₂, NOₓ, SOₓ, and O₂), including a mixture of compounds including H₂O and CO₂, i.e. which chemical composition has not been modified after the combustion reaction. Thus, the conversion is a reaction wherein the products of a combustion process, i.e. flue gas, are directly used as intrants of a downstream conversion/process. As will be described in more details below, in some embodiments, at least one reducing gas, acting as a reducing agent, can be added to the feed gas mixture including the untreated flue gas. The reducing gas can be H₂, CO, and/or a portion of the product gas mixture including H₂ and/or CO.

Since the flue gas is the product of an upstream combustion process, its composition, including the ratio H₂O/CO₂, can vary, for instance in accordance with the fuel composition and the combustion reaction conditions. Furthermore, the flue gas can be a combination of products from different chemical reactions.

The products of the conversion reaction include low-carbon fuels, such as syngas. The conversion reaction is performed using the iron-based catalyst, as described herein, being a porous structured catalyst and being provided, for example, as a wire mesh (steel wool), as a porous monolith, such as a porous structured catalyst (i.e. the catalyst prepared by foam coating) or a loose powder sintered catalyst (also referred to as pressure-less sintered catalyst), or as a bed of iron-based pieces/particles.

An electrical current can be applied to the reactor and, more particularly, to the catalyst when the conversion reaction is performed. In some embodiment, applying electricity directly to the catalytic medium, including the iron-based catalyst, can increase the CO₂ and H₂O conversions and improve the catalyst stability. In an embodiment, the electrical current can be generated from a renewable electricity source to further reduce the carbon intensity of the energy vectors produced. In a non-limitative embodiment, an electrical current between about 5 A and about 300 A and an electrical power between about 10 W and 2200 W can be applied to the catalytic medium, including the catalyst, during the CO₂ and H₂O conversion process.

The reaction temperature of the above-described conversion process is below the reaction temperature of conventional reforming processes, thereby lowering costs related to process heating. Furthermore, in comparison with classical PtX technologies, the above-described conversion process does not require a H₂ production step or a flue gas purification step, thereby it can be characterized by a relatively lower CAPEX and OPEX. The manufacturing cost of the metallic iron-based catalyst, which can efficiently convert CO₂ from flue gas of different sources and with different compositions, is relatively low cost.

More particularly, the iron-based catalyst can remove impurities, such as NOₓ and SOₓ, from the flue gas during the one-step upgrading conversion into low-carbon fuels, such as syngas. For instance and without being limitative, the flue gas can contain up to about 2000 ppm of NOₓ, up to about 100 ppm of SOₓ, up to about 150 ppm of particulate matter (PM), and up to 300 ppm of VOC. For instance and without being limitative, an untreated flue gas can contain at least 50 ppm of impurities, wherein the impurities are defined as a sum of the NOₓ, SOₓ, PM, and VOC content. In an embodiment, the iron-based catalyst can include iron oxides, which can be present in the pre-conversion reaction state of the catalyst or which can be formed in the catalyst during the conversion reaction. Such iron oxides can remove impurities such as SOₓ from the flue gas.

### Iron-Based Catalyst Preparation Implementations

As mentioned above, different porous metallic bodies, characterized by a high catalytically active surface area, can be conceived and used for designing the iron-based catalyst carrying out the conversion reaction. In an embodiment, the catalytically-active surface of the iron-based catalyst comprises essentially metallic iron. In an embodiment, the catalyst can have a porosity of at least 25% and, in another embodiment, of at least 50% and the pores of the catalyst can have a pore volume of at least 0.1 cm³/g. For example, at least 95% of the catalytically-active surface of the catalyst consists of an iron-based component and, in some embodiments, mostly metallic iron. As defined above, the metallic catalyst body structuring the resulting catalyst can include a porous monolith, steel wool, or iron-based pieces. The resulting catalyst can thus be referred to as a monolith-based catalyst, a steel wool-based catalyst or a bed of iron pieces/particles.

The catalyst body can be chosen is accordance to a targeted volume, porosity, rugosity, catalytically-active surface area for the resulting catalyst. In comparison, the volume of a catalyst bed formed by stacked steel wool is relatively important in comparison to a volume of a porous monolith including sintered iron. For example, the porous structured catalyst including the sintered iron monolith has a relatively high porosity and rugosity, which can be more adapted to catalyst promotion.

### Example Preparation of a Steel Wool-Based Catalyst

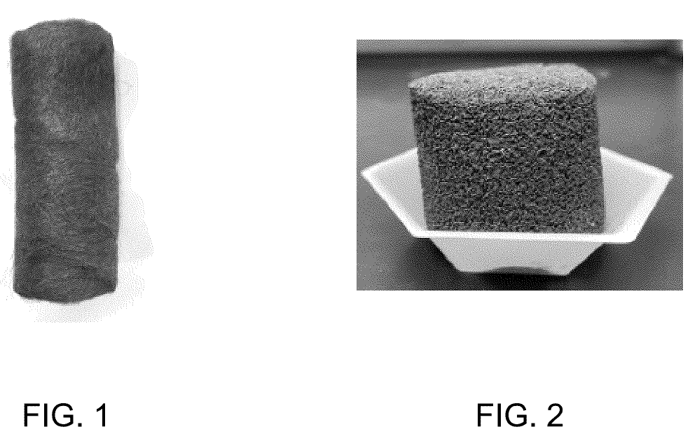

A steel wool-based catalyst, such as the one shown in FIG. 1, was prepared by overlaying alternate layers (80 g) medium grade (no 1) steel wool (Bulldog, Canada) including about 98.5 wt % Fe, 0.24 wt %, and impurities. For catalyst promotion and, more particularly, potassium (K) promotion, a wet impregnation method was used. A solution containing 5.0 wt % of potassium was prepared using KOH (85% purity, Alfa Aesar, USA) as a precursor. The catalyst was contacted with the solution for 30 minutes and dried under ambient conditions for 24 h.

It is appreciated that, in alternative embodiments, other catalyst promotors can be used. The catalyst promoters can include potassium (K), cobalt (Co), CaO, copper (Cu), nickel (Ni), CeO₂, and mixtures thereof.

### Example Preparation of a Porous Monolith Catalyst

### Iron Powder Sintering Over a Porous 3D Structure

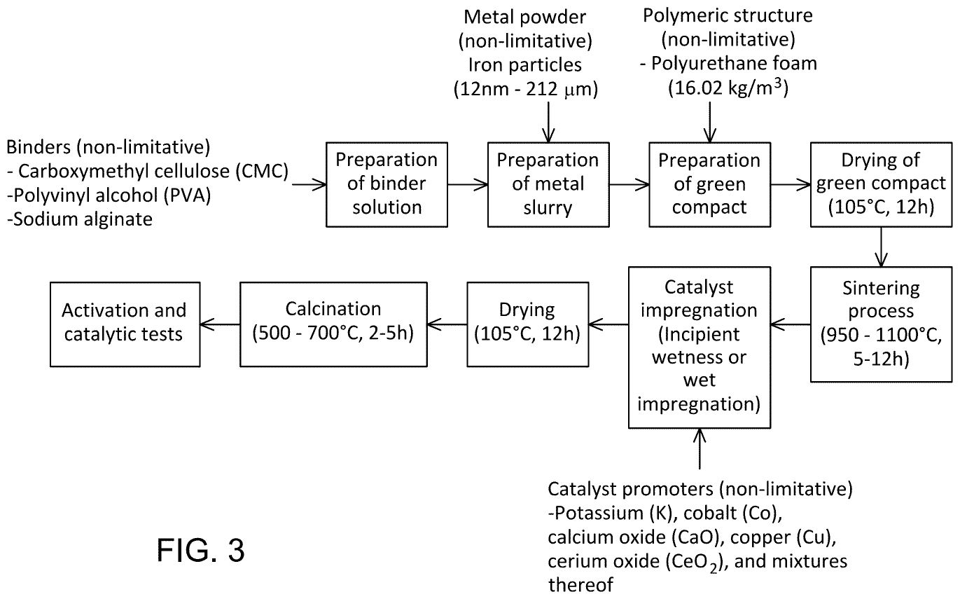

Referring now to FIG. 3, there is shown a first non-limitative embodiment to manufacture a porous structured metallic iron-based catalyst, such as the one shown in FIG. 2. The porous structured metallic iron-based catalyst is obtained by using a porous (or 3D network) structure as a support for iron powder sintering to form the body of the catalyst and confer its porosity. The porous structure can form a network of open cells or a grid and is made of a material having a sublimation/decomposition temperature below the iron sintering temperature (about 950° C.-1200° C.) and, in an embodiment above about 200° C. and below about 500° C. In a non-limitative embodiment, the material of the porous structure is a polymer, such as and without being limitative a polymeric foam (for instance, an open cell polymeric foam). For example, a polymeric foam, such polyurethane foam (having a decomposition temperature between about 270° C. and 300° C.) is provided. It is appreciated that other polymeric foam can be used such as and without being limitative, a polyethylene foam, and polystyrene. In still another alternative embodiment, the porous structure can be bio-based. For instance, and without being limitative, typha can be used.

Iron powder, mostly metallic iron, is applied superficially on the porous structure and then, the porous structure covered by iron powder is sintered by increasing the temperature to first decompose the material of the porous structured and then sinter the iron particles into an iron-based porous structure. The resulting catalyst, based on the catalyst body in the form of the porous monolith, can be qualified as “structured” because it takes the form of the porous structure that is used as a support for the iron particles in the synthesis process.

In another example, the porous structure that is used before the applying and sintering of the iron powder, can be and without being limitative, polyurethane foam. In an embodiment, to superficially coat the porous structure with iron particles, the porous structure, such as polyurethane foam having a density of 16.0 kg/m³, is soaked in a solution containing iron powder and binders. In an embodiment, the iron powder comprises iron particles having a particle size distribution between about 15 nm and about 212 μm. In a non-limitative embodiment, the binders can include sodium alginate, carboxymethyl cellulose, hydroxypropyl cellulose, stearic acid, polyvinyl butyral, and polyvinyl alcohol. In a non-limitative embodiment, the binder solution comprises 92.5 wt % of distilled water, 6.0 wt % polyvinyl alcohol, 1.0 wt % carboxy methyl cellulose and 0.5 wt % of sodium alginate. The binder solution is selected to obtain a viscous solution with the iron particles being in suspension to ensure a substantially uniform iron distribution. Then, the soaked polymeric foam is removed from the solution and dried for a drying period of time. In a non-limitative embodiment, the drying time can be in a range from about 5 hours to about 12 hours. In an embodiment, the drying is performed at a temperature higher than the room temperature and, in a particular embodiment, at a temperature higher than the water ebullition point, i.e. 100° C. Finally, the dried foam product is sintered at a temperature above the drying temperature for a sintering period of time. In an embodiment, the drying temperature is about 105° C. while the sintering temperature is about 900° C. It is appreciated that the sintering temperature can range from about 950° C. and 1200° C. for a sintering time ranging from about 5 hours to about 12 hours. In an embodiment, the catalyst obtained has a catalyst porosity above 50% vol.

### Loose Iron Powder Sintering

Loose powder sintering, also defined as pressure-less sintering, is defined as the filling/molding of a green compact with loose powder by pouring and/or vibrating without any compression and, then, heating to a sintering temperature in an appropriate atmosphere (Jabur, A. S. (2013). Effect of powder metallurgy conditions on the properties of porous bronze. Powder Technology, 237, 477-483). One of the advantages of the loose powder sintering method is the creation of a porous aggregate structure with no requirement of binders and other materials, rather than the metal or the alloy particles themself (Torres, Y., Lascano, S., Bris, J., Pavón, J., & Rodriguez, J. A. (2014). Development of porous titanium for biomedical applications: A comparison between loose sintering and space-holder techniques. Materials Science and Engineering: C, 37, 148-155.). It is a second non-limitative embodiment to manufacture the porous monolith body of the iron-based catalyst.

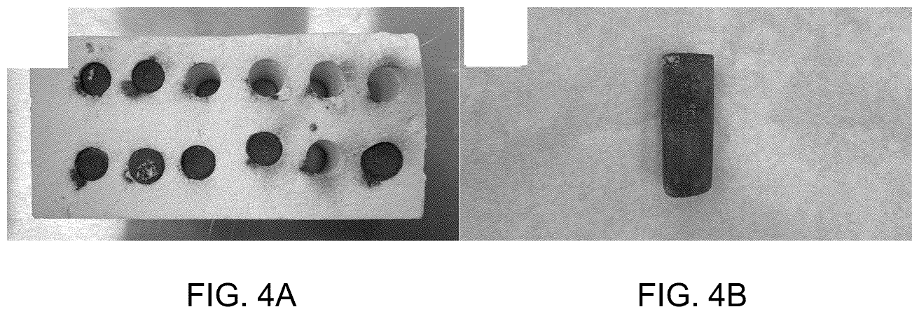

For example, a monolith-based catalyst was prepared by loose powder sintering. The catalyst was prepared using a mold made of quartz, an insulation material, including a plurality of cylindrical cavities, spaced apart from one another, as shown in FIG. 4A. In the non-limitative example shown, each one of the cylindrical cavities was at least 2.54 cm (1 in) of height and 6 to 10 mm of diameter. It is appreciated that the shape and the dimensions of the cavities can vary and, consequently, the shape and the dimensions of the metallic body of the iron-based catalyst. The cavities were filled with about to 2.5 to about 6.5 grams of metallic iron powder including particles smaller than 200 mesh (smaller than about 74 μm) to obtain green compacts. The green compacts contained in the quartz mold were sintered at 900° C. for 5 hours. The apparent density of the monolith iron-based catalyst, prepared with the loose powder sintering method, was around 3.69±0.22 g/cm³, representing a 2.1-fold increase when compared to the apparent density of the monolith-based catalyst prepared with the foam-coating method, which was 1.70±0.38 g/cm³.

The porous monolith catalysts, i.e. the loose powder sintered catalysts and the ones prepared with the foam-coating method, can be prepared at atmospheric pressure, without being in an inert/controlled atmosphere. Prior to the H₂O and CO₂ conversion process, the catalyst can be reduced to convert at least partially the iron oxides (FeO, Fe₂O₃, and/or Fe₃O₄) into metallic Fe, i.e. to increase the metallic iron content. For instance and without being limitative, the catalysts can be reduced under hydrogen flow (50 vol %, balanced with N₂, at 700° C. for 2 h).

The iron-based catalysts, following sintering, were characterized for their porosity according to a solvent replacement method, based on the technique described by Engstrand Unosson et al. (Engstrand Unosson, J., Persson, C., & Engqvist, H. (2015). An evaluation of methods to determine the porosity of calcium phosphate cements. Journal of Biomedical Materials Research Part B: Applied Biomaterials, 103(1), 62-71). More particularly, the sintered catalysts were dried at 105° C. for 2 h and then cooled down to room temperature in a desiccator. Once cooled, the catalysts were submerged in ethanol and transferred to a vacuum chamber where they underwent a series of depressurization (0.80 atm) and re-pressurization (1 atm) cycles, until no more solvent penetration was observed on the catalyst (at least 10 cycles). Porosity of the monolith-based catalyst prepared with the loose powder sintering method was around 34.6%+1.8%, which is comparable to the porosity of the monolith-based catalyst prepared with the foam-coating method, which was an average 30%. While the porosity of the monolith-based catalyst prepared via foam-coating was determined by the foam structure used as a shape for the catalyst synthesis, the resulting porosity of the monolith-based catalyst prepared by the loose powder sintering is determined by the natural flow of the powder into the mold.

### Catalyst Promoters

In some implementations, the iron-based catalyst can include at least one catalyst promoter impregnated on the metallic catalyst body (steel wool, monolith, or iron-based pieces/particles). For example, the catalyst promoters can be impregnated on the porous monolith of the iron-based catalyst following the catalyst sintering step. The catalyst promoters can include potassium (K), cobalt (Co), calcium oxide (CaO), copper (Cu), nickel (Ni), CeO₂, and mixtures thereof. For instance, the catalyst promoters can be impregnated on the metallic catalyst body by incipient wetness impregnation or by wet impregnation.

For example, the preparation of the monolith-based catalyst via foam-coating and sintering was also based on the technique described by Liu et al. (Liu, P., Zhang, D., Dai, Y., Lin, J., Li, Y., & Wen, C. (2020). Microstructure, mechanical properties, degradation behavior, and biocompatibility of porous Fe—Mn alloys fabricated by sponge impregnation and sintering techniques. Acta Biomaterialia, 114, 485-496), with minor modifications. First, a binder solution was prepared containing 92.5 wt % of distilled water, 6.0 wt % polyvinyl alcohol (PVA; (C₂H₄O)ₓ, 86-89% hydrolyzed, low molecular weight, Alfa Aesar), 1.0 wt % carboxy methyl cellulose (CMC; C₈H₁₆O₈, Sigma-Aldrich) and 0.5 wt % of sodium alginate ((C₆H₈O₆) n, low viscosity, Alfa Aesar). The CMC was dissolved under magnetic stirring at 80° C. After the solution cooled down to room temperature, the PVA and the sodium alginate were dissolved under magnetic stirring. The metal slurry was obtained by mixing iron powder (99+wt %,-200 mesh, Alfa Aesar) and the binder solution with a proportion of 60:40 wt % (iron powder:binder solution). The iron-based suspension was homogenized during 20 minutes prior to foam-coating. A polyurethane foam (density: 16.02 kg/m³) was impregnated with the metal slurry to obtain a green compact. The green compact was dried at 105° C. overnight and sintered at 950° C. for 12 h.

For both porous monolith catalysts, i.e. the loose powder sintered catalysts and the ones prepared with the foam-coating method, catalyst promotion and, more particularly, potassium promotion, was performed via incipient wetness impregnation over the catalyst after the thermal treatment. Alkaline promotion was carried out using a 2M KOH solution. After solution impregnation, the catalyst was dried at 105° C. for 12 h. In an alternative embodiment, the catalyst can be dried at room temperature for a longer time period. The dried and promoted catalyst can then be subjected to a calcination step carried out at a temperature ranging between about 500° C. to about 700° C. for a calcination time ranging between about 2 hours to about 5 hours. In the examples below, the dried and K-promoted catalyst was calcined at 700° C. for 2 hours.

### Catalyst Evaluation

### Example Steel Wool-Based Catalyst

The prepared steel wool-based catalysts were tested for the syngas production at a semi-pilot scale setup using a vertical Inconel-alloy reactor (id=5.08 cm, h=120 cm) placed in a tubular oven equipped with three heating zones. A mixture of CO₂, H₂O and N₂ was used at a total flowrate of 650 mL/min (GHSV=126 h⁻¹) and a composition of 61.5% of H₂O, 30.8% of CO₂ and 7.7% of N₂ (vol %). The reaction was performed between 60° and 900° C. under atmospheric pressure. When electricity was used, 300 W of power (I=100 A) was applied directly to the catalyst medium.

### Example Porous Monolith-Based Catalyst

The prepared monolith-based catalysts were tested for the syngas production using simulated and real flue gas mixtures at various temperatures. For the simulated flue gas, the tests were conducted at a semi-pilot scale setup using a vertical Inconel-alloy reactor (id=5.08 cm, h=120 cm) placed in a tubular oven equipped with three heating zones. A simulated flue gas mixture of CO₂, H₂O and N₂ was used at a total flowrate of 1000 mL/min (GHSV=310 h⁻¹) and a composition of 70% N₂, 20% H₂O and 10% CO₂ (vol %). The conversion reaction was performed at reaction temperatures between 400° C. and 800° C. under atmospheric pressure. Prior to the tests, 10 g of porous monolith catalysts were heated to 700° C. under N₂ atmosphere (1000 mL/min) and reduced in-situ at this temperature under a 50% H₂/N₂ stream (1000 mL/min) for 2 h (% vol.). When electricity was used, 300 W of power (I=100 A) was applied directly to the catalytic medium, i.e. the porous monolith-based catalyst.

For the real flue gas, the tests were conducted at a bench-scale setup using a vertical Inconel-alloy reactor (id=1.27 cm, h=30.48 cm) placed in a tubular oven equipped with one heating zone. A real flue gas mixture was obtained from a portable dual-fuel generator (model H03651, Firman) powered by gasoline (94 octane) with an average volumetric composition of 83.02±2.63% N₂, 9.33±0.31% CO₂, 4.18±0.29% CO, 3.46±0.53% O₂, 61±3 ppm NOₓ, 58±6 ppm SO₂ (on dry basis). The reaction was performed at 700° C. under atmospheric pressure at a total flowrate of 50 mL/min of flue gas (GHSV=310 h⁻¹). Prior to the tests, the catalysts were heated to 700° C. under N₂ atmosphere (100 mL/min) and reduced in-situ at this temperature under a 50% H₂/N₂ stream (100 mL/min) for 2 h (% vol.).

For both reaction systems, the gas products were analyzed by a TCD-TCD-FID gas chromatography (model Scion 456 GC, Bruker), by a NO/NOₓ detector (model RASI 300C, Eurotron; range 0-5000 ppm) and by a SO₂ analyzer (model BW Solo SO₂, Honeywell; range 0-100 ppm).

Results for Conversion of CO₂ and H₂O into Syngas Over Steel Wool Catalyst

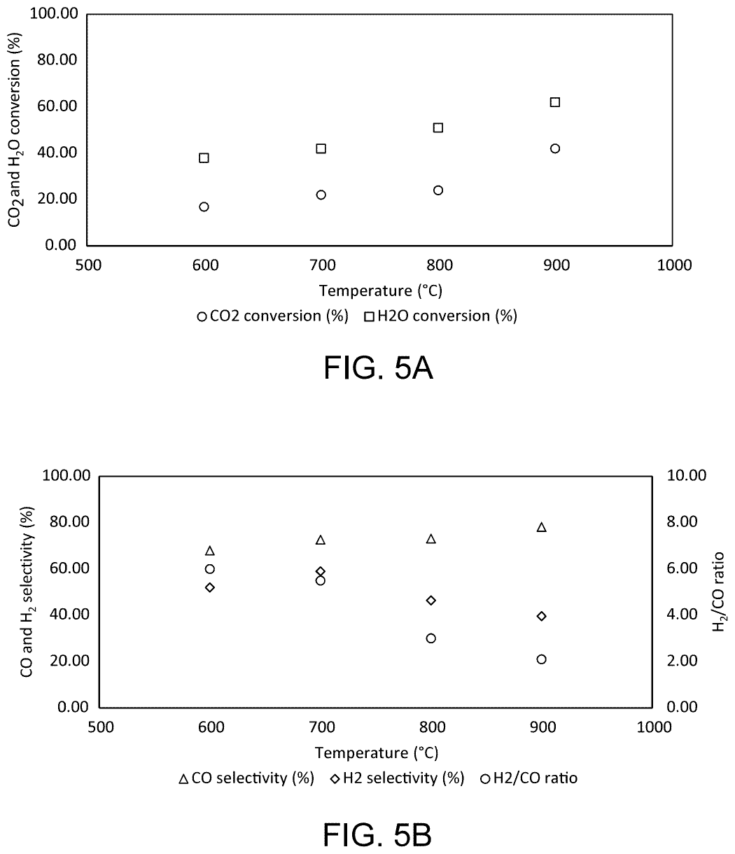

FIG. 5 shows the CO₂ and H₂O conversions as well as the CO (▴) and H₂ (♦) selectivity and the H₂/CO ratio (x), as a function of temperature, for a reaction conversion carried out in the presence of the steel wool-based catalyst and without electricity, i.e. without electric current applied to the steel wool-based catalyst.

FIG. 5A shows that, as expected, the CO₂ and H₂O conversion rates increased with the reaction temperature. In the following examples, the conversion rates are given as mol percent. More particularly, the CO₂ conversion rate increased from 16% to 42% from 600° C. to 900° C., respectively, while H₂O conversion rate increased from 60% to 99% from 600° C. to 900° C., respectively. High selectivity towards syngas was observed for 600-700° C. The decrease on the H₂/CO ratio for temperatures higher than 800° C. comes with a decrease on H₂ selectivity (FIG. 5B). This behavior can indicate the occurrence of Reverse Water-Gas Shift reaction (RWGS, Equation 4), which is favored at high reaction temperatures.

CO₂+H₂↔CO+H₂O ΔH°=42.1 KJ/mol (4)

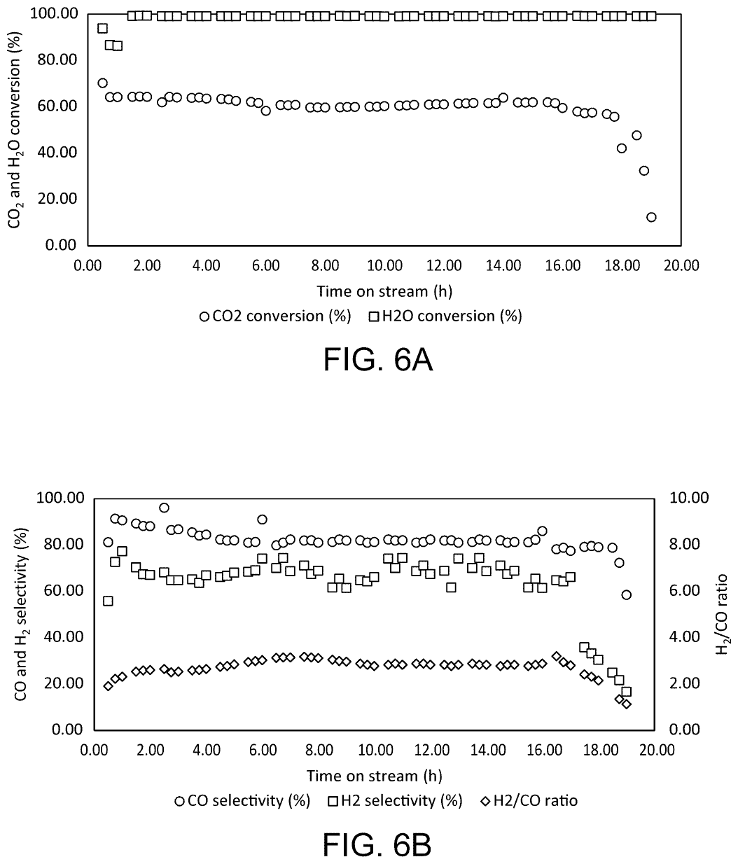

The effect of potassium promotion was investigated. It has already been reported that the presence of alkaline sites favors CO₂ conversion by favoring the CO₂ chemisorption to the surface of the catalytic metal (Choi, P. H., Jun, K.-W., Lee, S.-J., Choi, M.-J., & Lee, K.-W. (1996). Hydrogenation of carbon dioxide over alumina supported Fe-K catalysts. Catalysis Letters, 40 (1-2), 115-118; Wei, J., Ge, Q., Yao, R., Wen, Z., Fang, C., Guo, L., Xu, H., & Sun, J. (2017). Directly converting CO₂ into a gasoline fuel. Nature Communications, 8 (May), 1-8). In addition, the direct use of electricity through the catalytic medium may allow for the electrons provided by the electric current to participate in the reaction, in a novel electrocatalytic approach that would not require the structure of an electrochemical cell. FIG. 6 shows the results for the K-promoted steel wool catalyst for the tests carried with electricity (300 watts, 100 A) were applied to a catalytic medium including the K-promoted steel wool catalyst). The conversion of CO₂ and H₂O over the steel wool-based catalyst promoted with potassium at a reaction temperature (T) of 700° C., an electrical current of 100 A applied to the catalytic medium, and a gas hourly space velocity (GHSV) of 126 per hour (h⁻¹) was increased to around 60-70% (FIG. 6A) with stability for at least 16 h, with a H₂/CO ratio between 2.6-2.9 (FIG. 6B).

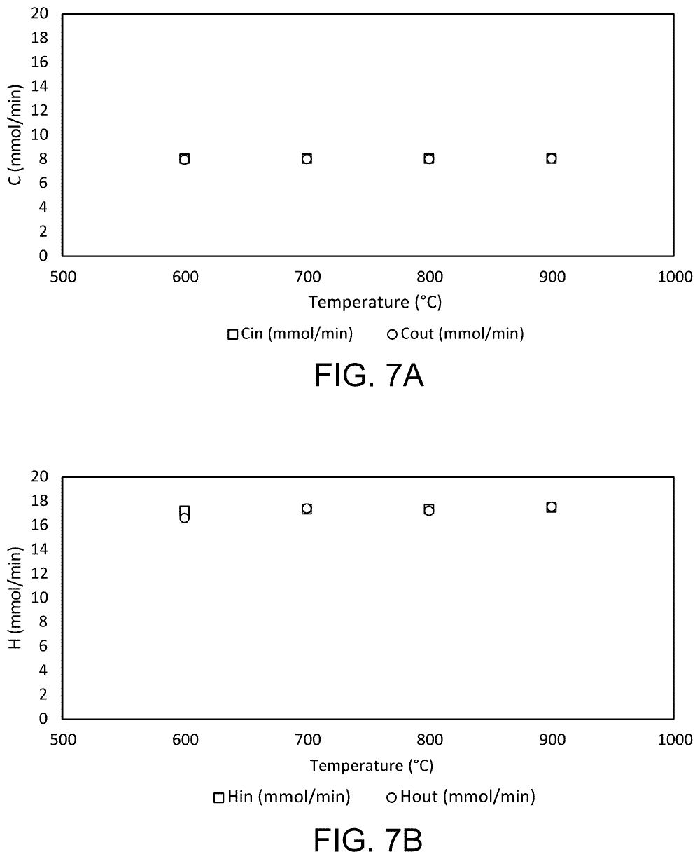

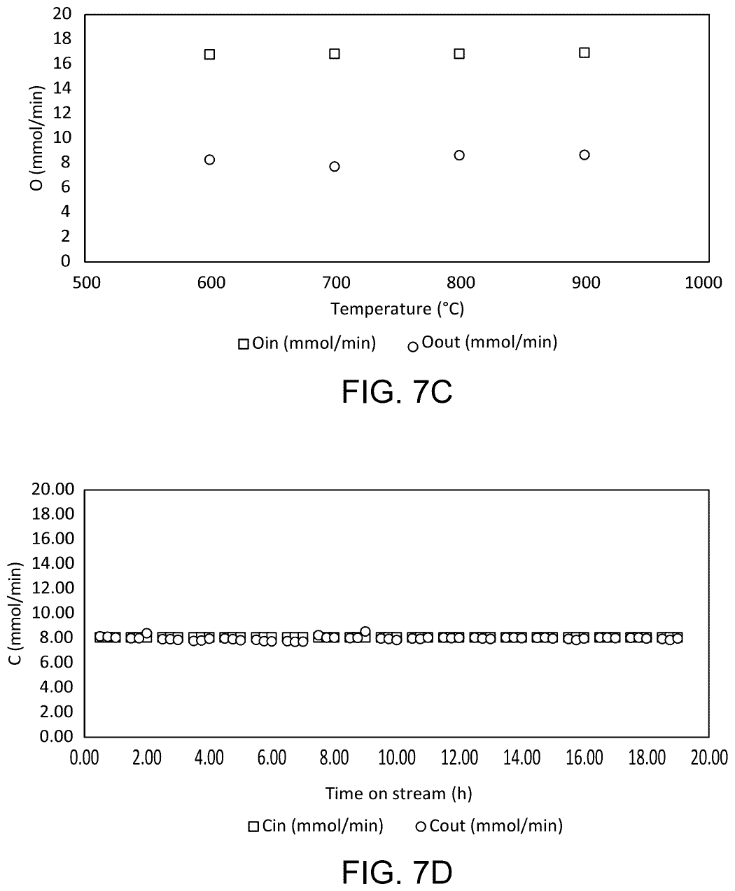

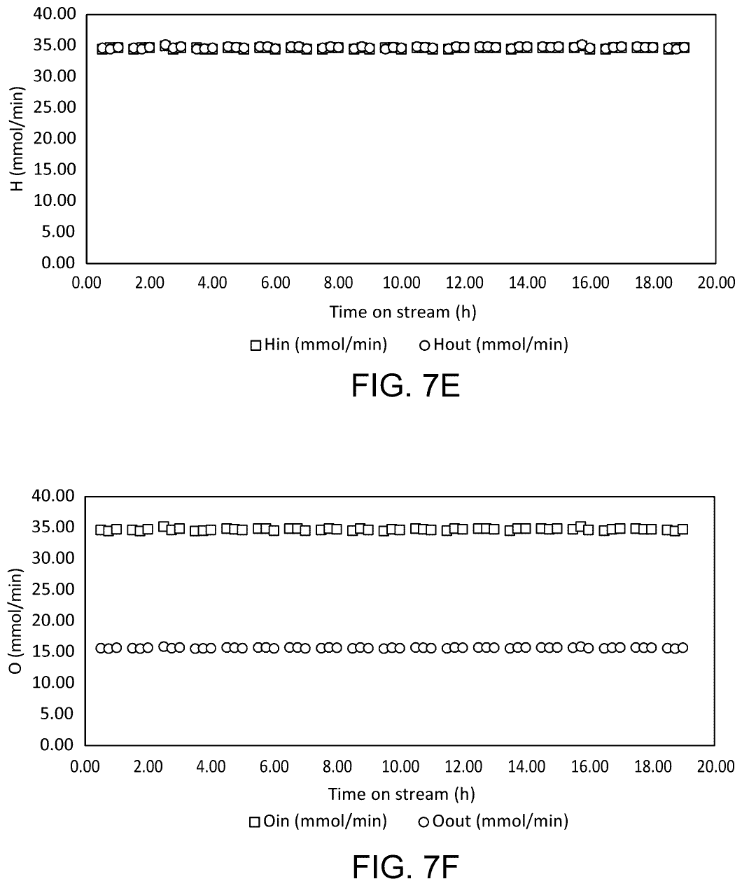

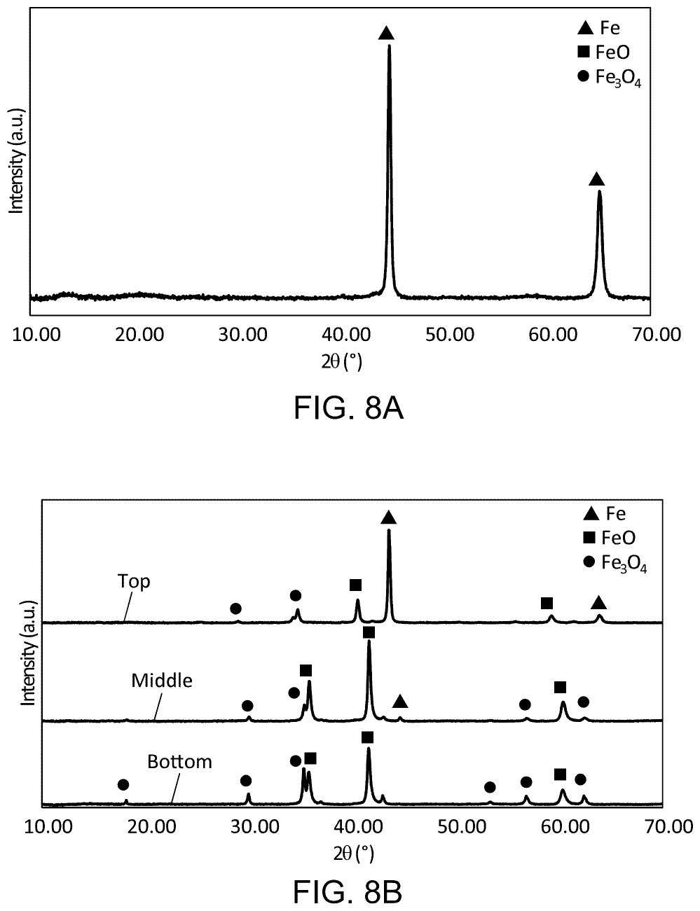

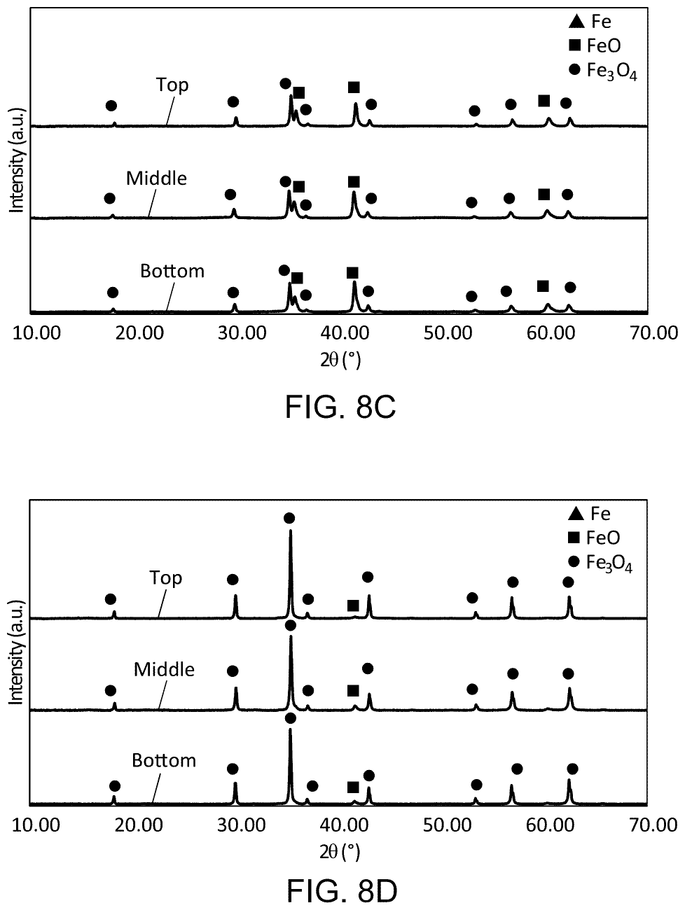

Carbon, hydrogen and oxygen balances for the tests with steel wool, described above, are shown in FIG. 7. The carbon (FIGS. 7A and 7D) and hydrogen (FIGS. 7B and 7E) contents in the gas flow at the reactor inlet and outlet are similar on the tests carried at different temperatures and on the stability tests carried with electricity (I=100 A, P=300 W). On the other hand, the oxygen balances (FIGS. 7C and 7F) reveal a major discrepancy on the content of oxygen between the reactor inlet and outlet streams. The accumulation of oxygen on the Fe-based catalyst in the form of iron oxides has already been proven for the steel-wool catalyst, when XRD analysis showed the conversion of metallic iron into iron (II) oxides as the reaction progresses (FIG. 8).

Results for Conversion of a Simulated Flue Gas into Syngas Over a Porous Monolith-Based Catalyst (Prepared Via Foam Coating)

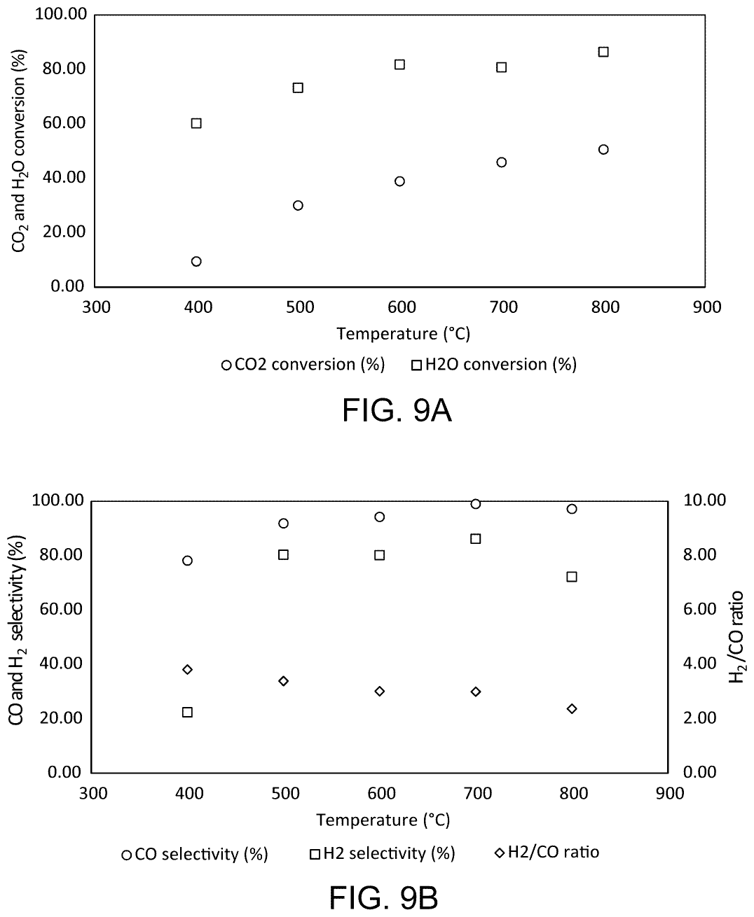

Tests with a simulated flue gas were conducted using a mixture of CO₂, H₂O and N₂, which are the main components of flue gas. The influence of the operating temperature, between a temperature range of 400° C. to 800° C., on the porous monolith-based catalyst performance and the composition of the produced syngas was evaluated. FIG. 9 presents the results for the conversion of a simulated flue gas over the Fe-based catalyst without electrical current.

The CO₂ and H₂O conversion increase with the reaction temperature up to 800° C. (FIG. 9A), as expected. CO₂ conversion increased from about 9% at a reaction temperature of 400° C. to about 51% at a reaction temperature of 800° C., and H₂O conversion increased from about 60% at a reaction temperature of 400° C. to around about 86% at a reaction temperature of 800° C. High selectivity towards CO and H₂ (FIG. 9B), especially at reaction temperatures between 500° C. and 700° C. (above about 90% and about 80% for CO and H₂, respectively) reveals that syngas with high purity is produced with the above-described conversion process including the use of the metallic iron-based porous catalyst. As the inlet feed is more concentrated in H₂O and the H₂O conversion is much higher than the CO₂ conversion for a given temperature, a H₂-rich syngas (high H₂/CO ratio) is obtained. The H₂/CO ratio reaches 3.8 for a reaction temperature of 400° C. and slowly decreases with the temperature increase to reach 3.0 for a reaction temperature of 700° C. and 2.4 for a reaction temperature of 800° C.

For reaction temperatures between 600° C. and 700° C., the H₂/CO ratio of the produced syngas fluctuates around 3.0. However, a higher CO₂ conversion is obtained for a reaction temperature of 700° C. (47% and 55% at 600° C. and 700° C., respectively). This syngas composition is suitable, i.e. meets the requirements, for several downstream processes such as a Fischer-Tropsch synthesis for fuel production. The decrease of the H₂/CO ratio at a reaction temperature of 800° C. comes with a decrease of the H₂O conversion (FIG. 9A) and H₂ selectivity (FIG. 9B), which can indicate the occurrence of RWGS reaction (Equation 3), which is favored at high temperatures.

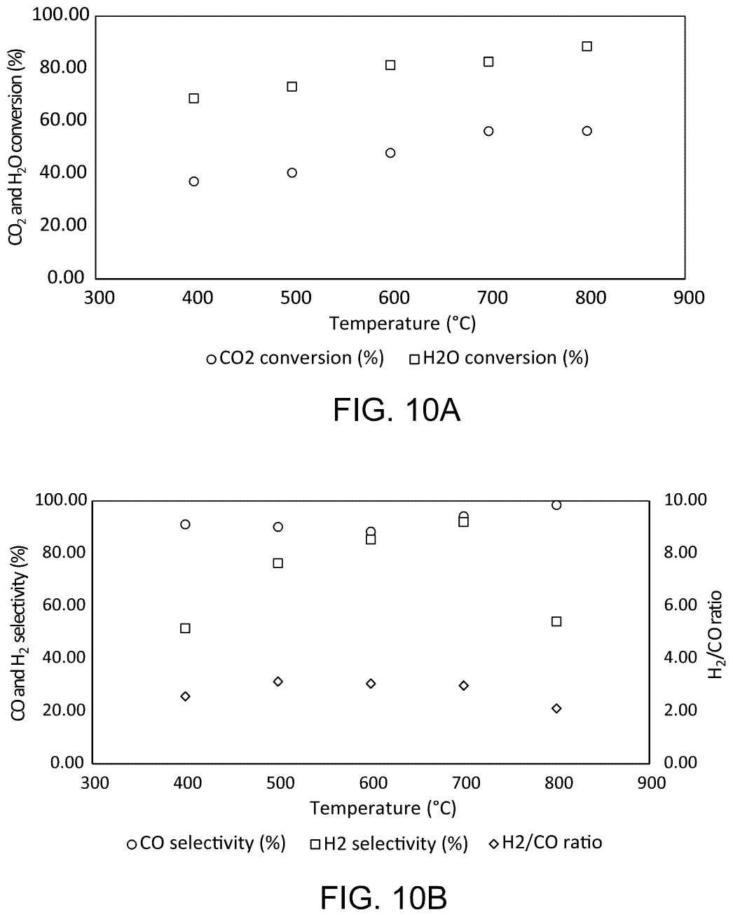

FIG. 10 shows the conversion of simulated flue gas over the porous monolith-based catalyst as a function of the reaction temperature for the tests carried out with electricity applied to the catalyst (P=300 W, I=100 A). The CO₂ and H₂O conversion increased with the reaction temperature up to a reaction temperature of 800° C. (FIG. 10A). The CO₂ conversion increased from about 37% to about 56% for a reaction temperature between 400° C. and 800° C., respectively. When electricity was applied to the catalyst during the conversion reaction, the CO₂ conversion was higher than for the tests carried out without electricity, especially for lower reaction temperatures (about 37% and about 9% at a reaction temperature 400° C. for tests carried out with and without electricity, respectively). High syngas selectivity was obtained for reaction temperatures between 500° C. and 700° C. (above about 88% and about 76% for CO and H₂, respectively) while the syngas composition produced varied between H₂/CO=2.6 to H₂/CO=2.1, with a favorable H₂/CO=3.0 at reaction temperatures of 600-700° C. (FIG. 10B). The decrease on H₂ selectivity at 800° C. can indicate the occurrence of a RWGS reaction over the porous monolith-based catalyst at higher temperatures (Equation 3).

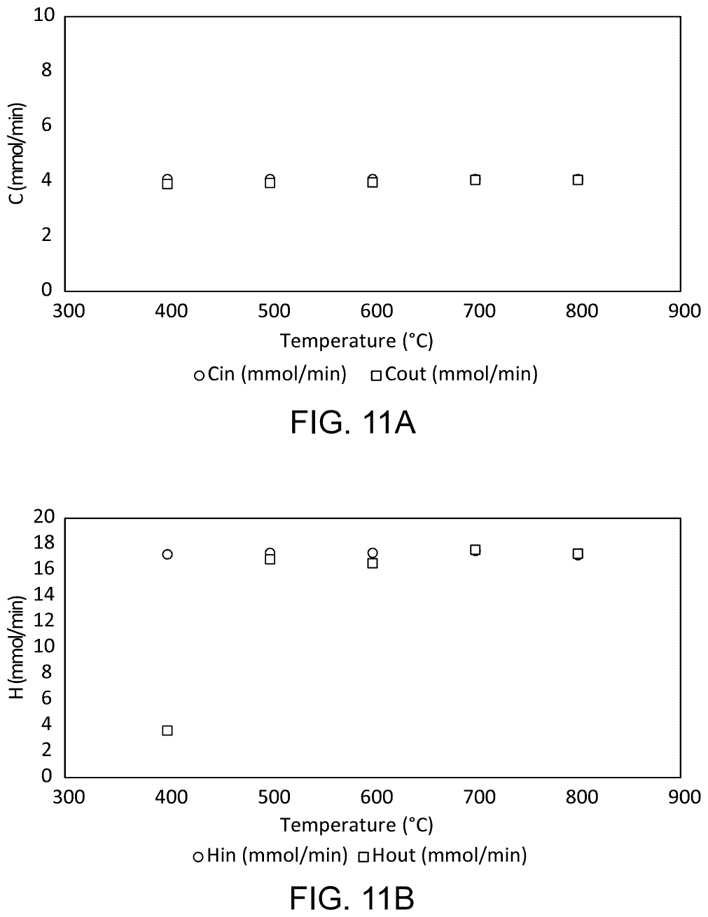

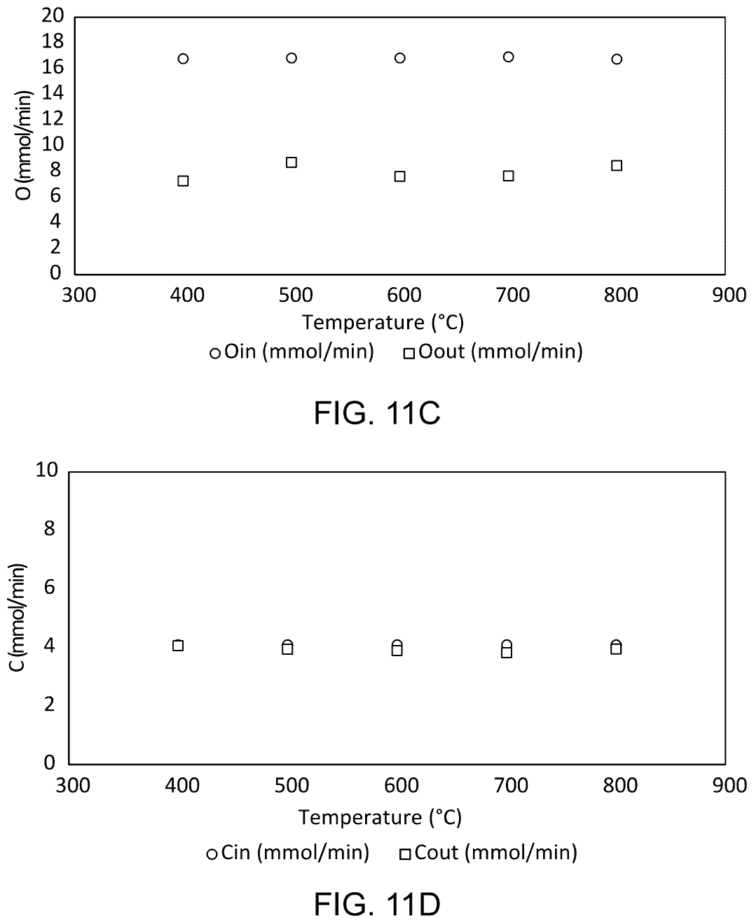

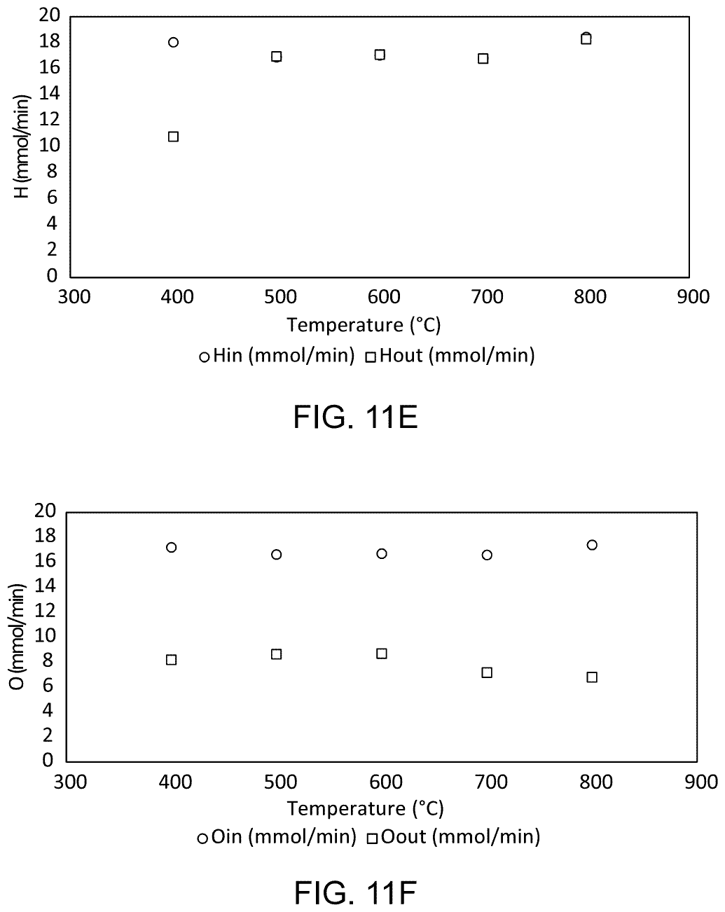

Carbon, hydrogen and oxygen balances are shown in FIG. 11. Carbon (FIGS. 11A and 11D) and hydrogen (FIGS. 11B and 11E) contents in the gas flow at the reactor inlet and outlet present a good agreement at all temperatures, except at a reaction temperature of 400° C., when there is a significant difference on the hydrogen balance. This difference might be related to the formation of byproducts at lower temperatures that can either be adsorbed on the catalystic surfaces (intermediate species) or recovered in the liquid phase. On the other hand, the oxygen balances (FIGS. 11C and 11F) reveal a major discrepancy on the content of oxygen between the reactor inlet and outlet streams. As previously observed with the steel wool-based catalyst, (FIGS. 7 and 8), this behavior is also observed for the porous monolith-based catalyst having superficial sintered iron.

Results for Conversion of an Untreated Real Flue Gas Mixture into Syngas Over a Porous Monolith-Based Catalyst (Prepared Via Foam Coating)

The tests carried out with the simulated flue gas showed the potential of this process to convert flue gas mixtures into relatively high purity syngas, which composition, characterized amongst others by its H₂/CO ratio, can be varied. Additional tests were also carried out with an untreated real flue gas stream to assess the influence of other flue gas components such as CO and O₂, as well as impurities such as NOₓ and SO₂ on the catalytic performance. The real flue gas mixture was obtained from a portable dual-fuel generator (model H03651, Firman) powered by gasoline (94 octane) with an average volumetric composition of 83.02±2.63% N₂, 9.33±0.31% CO₂, 4.18±0.29% CO, 3.46±0.53% O₂, 61±3 ppm NOₓ, and 58±6 ppm SO₂ (dry basis).

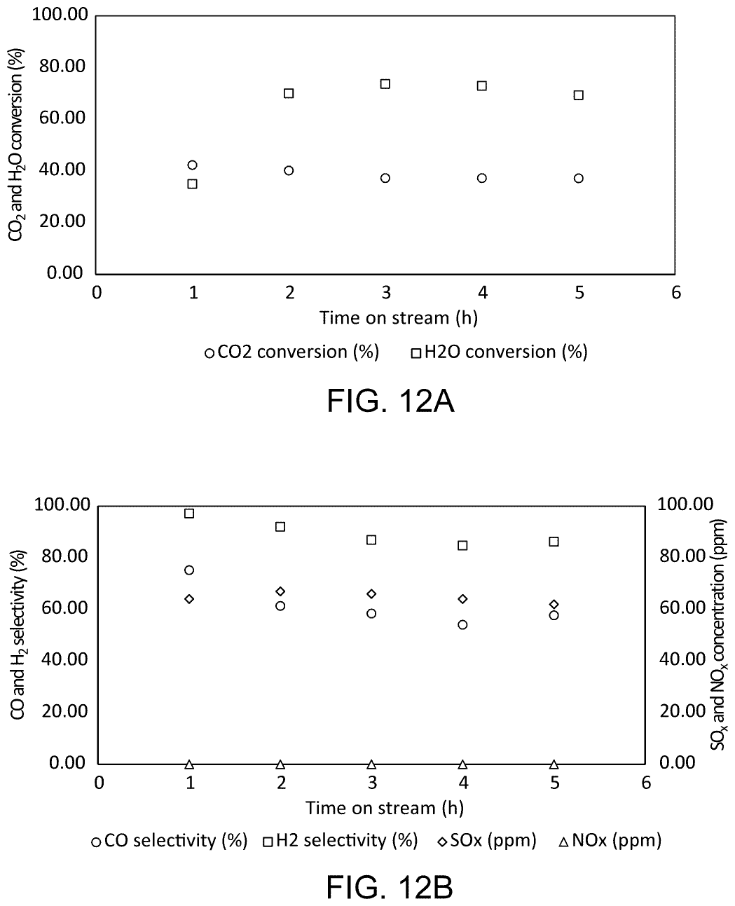

FIG. 12 presents the results for direct conversion of the untreated flue gas into syngas over the porous monolith-based catalyst and more particularly, a non-promoted porous monolith-based catalyst. The conversation reactions were carried out at a reaction temperature of T=700° C. with a GHSV=310 h⁻¹. The above-described tests carried out with simulated streams showed that, at a reaction temperature of 700° C., a favorable syngas composition (H₂/CO=3.0) with a high CO₂ conversion (X_{CO}_{₂}=45%) can be obtained. FIG. 12A shows that the CO₂ conversion fluctuated between about 37% to about 40% during the 5 hours during which the catalyst was continuously exposed to a stream of untreated flue gas (Time on stream (TOS)=5 hours). The H₂O content in the flue gas mixture was low and far from a theoretical composition of H₂O/CO₂=1.1 that could be expected from a combustion process. The presence of CO and O₂ in the flue gas indicates that the combustion process performed by the portable dual-fuel generator was not complete, i.e., part of the fuel was not fully converted into CO₂ and H₂O. The combination of an incomplete combustion with the possibility of water condensation inside the flue gas capturing system led to a H₂O/CO₂ ratio below 0.1 in the flue gas composition, which, in turn, impacted on the H₂ content of the produced syngas. However, the data shows a high syngas selectivity (above about 60% and about 85% for CO and H₂, respectively, as shown in FIG. 12B), which is in conformity with the results previously observed for the simulated streams of flue gas.

The presence of other flue gas components, such as CO and O₂, and impurities, such as SO₂ and NOₓ, did not seem to impact the catalyst performance. More particularly, no NOₓ was detected in the product gas stream at the reactor outlet during the tests performed with the non-promoted porous monolith-based catalyst, which indicates that the NOₓ was completely converted during the reaction (FIG. 12B). This result suggests that the metallic iron-based catalyst is also capable of eliminating this impurity from the flue gas. A relatively constant SO₂ concentration, around about 60 ppm, was observed in the product gas stream at the reactor outlet, indicating that the SO₂ present in the flue gas was not interacting with the porous metallic iron-based catalyst during the reaction.

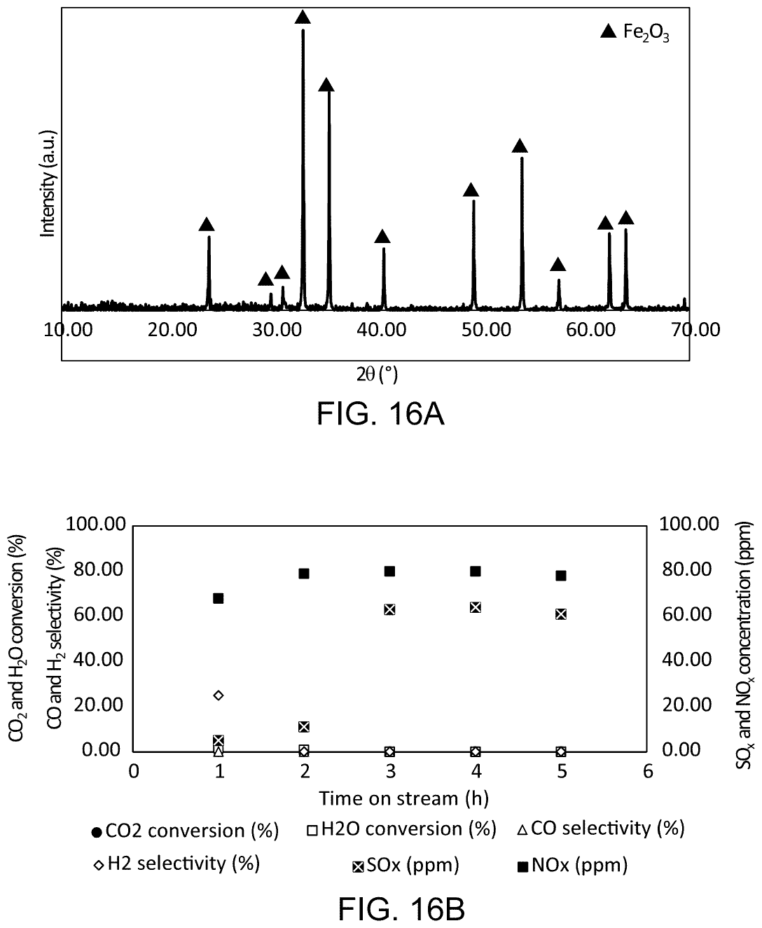

However, the SO₂ present on the flue gas can be partially removed when a deactivated porous metallic iron-based catalyst is used. It has been observed that the Fe₂O₃ present on the deactivated porous metallic iron-based catalyst can treat about 80% (vol.) of the SO₂ present inside the flue gas for a limited period of time (about 2 h), as shown in the example below in reference to FIG. 16.

Thus, there can be provided a process to at least partially remove SOₓ, such as SO₂, from a gas mixture by contacting the gas mixture with an iron-based catalyst including iron oxides, such as Fe₂O₃. In an embodiment, the catalyst can comprise a deactivated metallic iron-based catalyst, i.e. a metallic iron-based catalyst which has been previously used to convert a gas mixture including CO₂ and H₂O into a low-carbon fuel including at least a mixture of H₂ and CO and which comprises iron oxides, such as Fe₂O₃. In an embodiment, the iron oxides were formed during a conversion reaction wherein CO₂ and H₂O were converted into a low-carbon fuel including at least a mixture of H₂ and CO. In an embodiment, the gas mixture from which SOₓ is removed includes CO₂ and H₂O.

In an embodiment, to be active during the SOₓ partial removal (or sequestration), the iron of the iron-based catalyst is mostly oxidized iron, including Fe₂O₃. More particularly, oxidized iron is the most active phase for the SOₓ partial removal and the component having the highest concentration in the catalyst. In some embodiments, the iron oxide content in the catalyst composition is the component with the highest concentration without compulsorily exceeding 50 wt %. In other embodiments, the iron oxide content in the catalyst composition is about 50 wt %. In other embodiments, the catalyst composition can be essentially iron oxides, except for unavoidable impurities.

In an embodiment, the gas mixture comprises flue gas and can include other contaminants in addition to SOₓ, such as and without being limitative NOₓ, particulate matter, and volatile organic compounds (VOC). It can further include other constituents such as O₂, N₂, and CO.

In an embodiment, the reaction, i.e. the contact between the gas mixture and the iron-based catalyst including iron oxides, takes place at atmospheric pressure and at a reaction temperature ranging between about 400° C. and about 950° C.

In an embodiment, the process is performed by contacting the gas mixture including CO₂, H₂O and SOₓ with an active porous metallic iron-based catalyst, which will convert the CO₂ and H₂O into a low-carbon fuel including at least a mixture of H₂ and CO, and the deactivated iron-based catalyst including iron oxides, which will remove the SOₓ present inside the reactant gas mixture. In an embodiment, the process can be performed for a reaction duration during which the active porous metallic iron-based catalyst and the deactivated iron-based catalyst including iron oxides simultaneously convert the CO₂ and H₂O into a low-carbon fuel including at least a mixture of H₂ and CO and remove the SOₓ present inside the reactant gas mixture. Thus, in an embodiment, both reactions can take place simultaneously. In an alternative embodiment, the reactant gas mixture can first contact the deactivated iron-based catalyst including iron oxides to at least partially remove the SOₓ contained therein and, then, contact the active porous metallic iron-based catalyst to convert the CO₂ and H₂O into a low-carbon fuel including at least a mixture of H₂ and CO.

Thus, in a continuous reactor, the reaction chamber can contain both the active porous metallic iron-based catalyst and the deactivated iron-based catalyst including iron oxides. Alternatively, the housing can include two reaction chambers with an upstream one including containing the deactivated iron-based catalyst including iron oxides and the downstream one containing the active porous metallic iron-based catalyst. Still in an alternative embodiment, inside the reaction chamber, the two catalysts can be configured in a manner such that the reactant gas flow first contact the deactivated iron-based catalyst including iron oxides before contacting the active porous metallic iron-based catalyst.

In an embodiment, after the reaction duration, for instance two hours, the deactivated iron-based catalyst can be removed from the reaction chamber(s), new active porous metallic iron-based catalyst can be introduced into the reaction chamber(s), and the active porous metallic iron-based catalyst that was contained inside the reaction chamber(s), which now includes iron oxides following the conversion reaction that took place can be used as deactivated iron-based catalyst including iron oxides for a subsequent reaction duration.

Results for Conversion of an Untreated Real Flue Gas Mixture into Syngas Over a Monolith-Based Catalyst (Prepared Via Loose Iron Powder Sintering)

The performance of the monolith-based catalyst prepared by loose powder sintering, i.e. the loose powder sintered metallic iron-based catalyst, was evaluated with 5 wt % K promotion. The catalytic performance was compared with the results previously obtained for the monolith-based catalyst prepared by foam-coating. Prior to evaluation, both catalysts were reduced under hydrogen flow (50 vol %, balanced with N₂, at 700° C. for 2 h). The catalytic tests were carried out using the bench-scale reactor, at T=700° C., flue gas flowrate (Q_{Flue gas})=50 mL/min, GHSV=310 h⁻¹. As the composition of the inlet flue gas influences not only the composition of the produced syngas, but also the catalyst stability. Therefore, two H₂O/CO₂ ratio were considered and, more particularly, a ratio of 0.3-0.32 for the first 3.5 hours and a ratio of 2.0 for the next 2.5 hours.

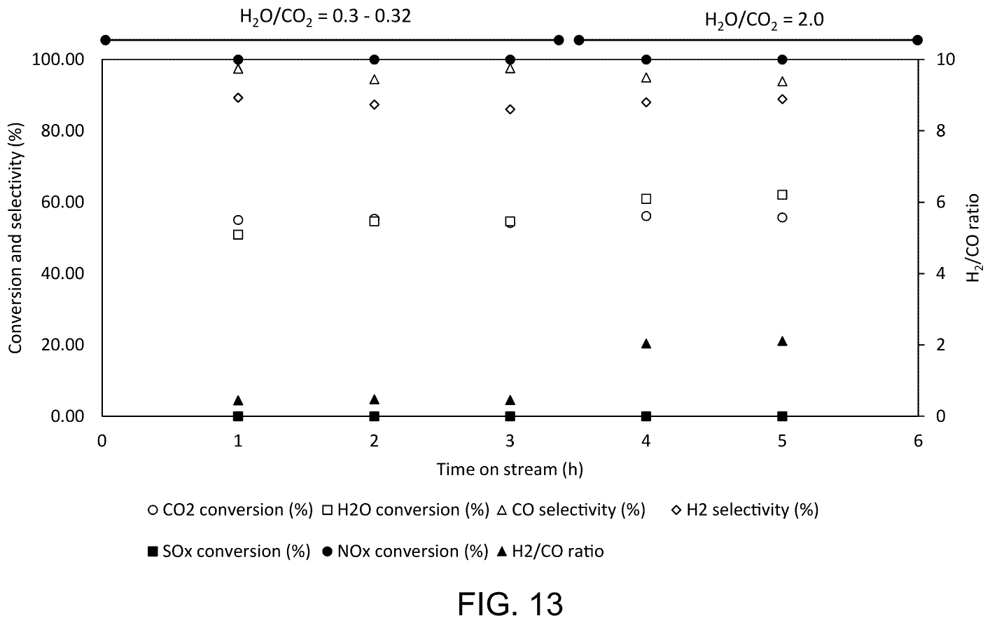

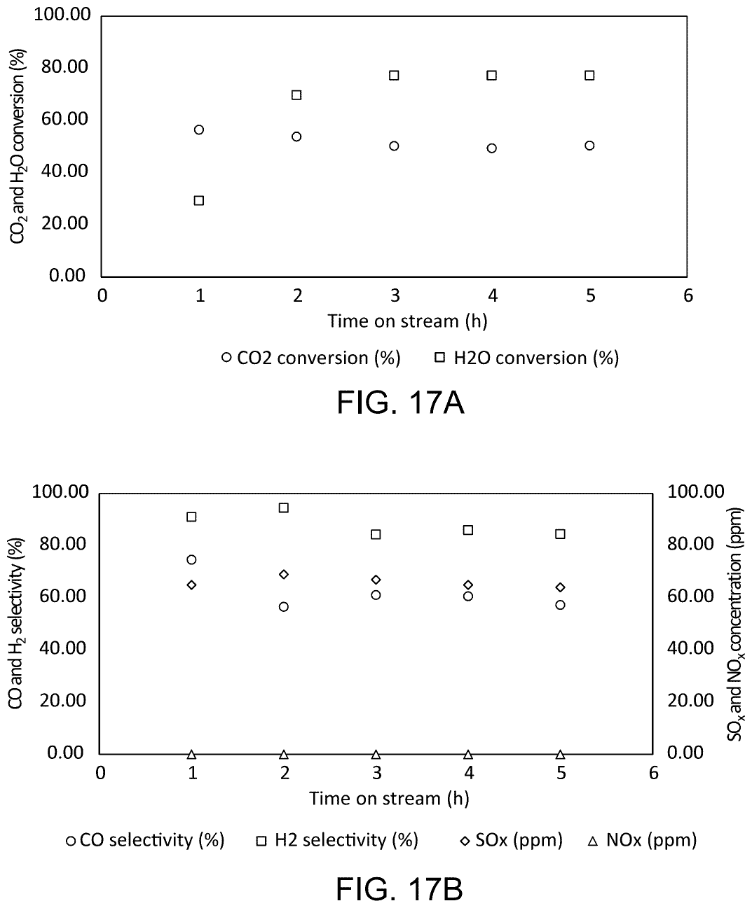

FIG. 13 shows that the catalytic performance of the monolith-based catalyst obtained via loose powder sintering is similar to the performance for the monolith-based catalyst obtained with the foam-coating method (see FIGS. 10A and 17A). CO₂ conversion was around 57% for both H₂O/CO₂ conditions tested and is slightly lower than what was observed for the catalyst obtained with the foam-coating method (60% CO₂ conversion), which might be due to some diffusional limitations. H₂O conversion between 55-60% was also comparable to what was previously observed. Syngas selectivity was high (>87%) and the H₂/CO ratio of the produced syngas was directly affected by the H₂O/CO₂ inlet composition. For inlet H₂O/CO_{2=0.3}-0.32, syngas composition was around H₂/CO=0.4-0.45, while for H₂O/CO_{2=2.0}, syngas composition was around H₂/CO=2.0-2.1.

### Stability Tests

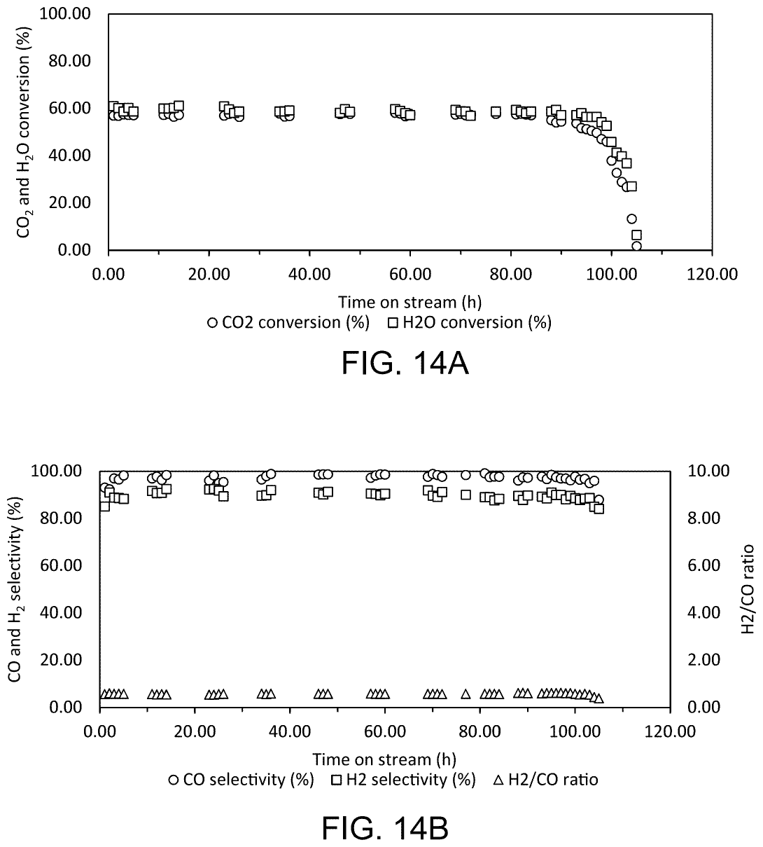

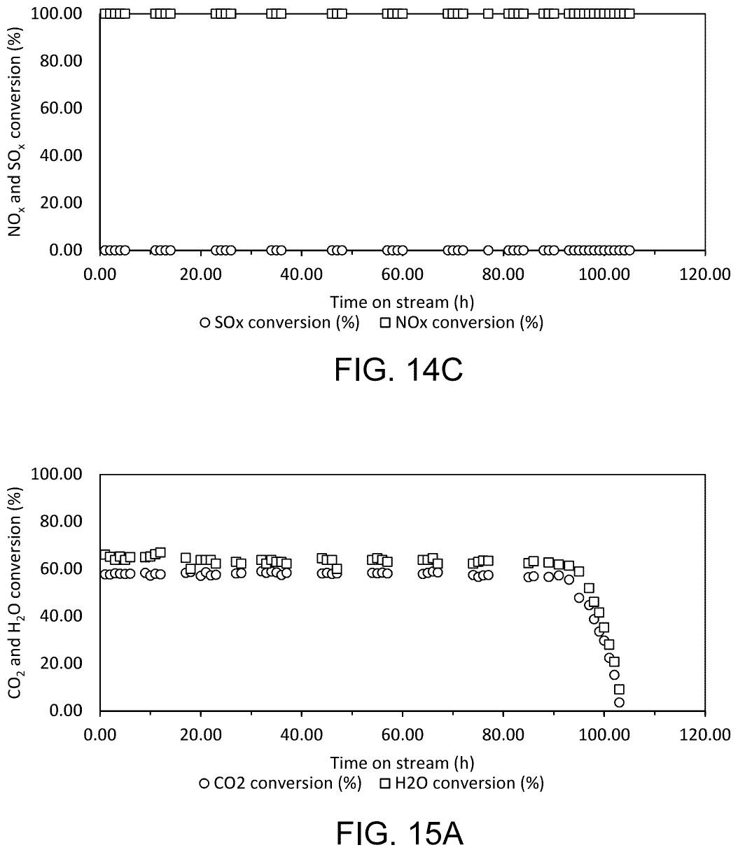

Based on the results of the catalytic performance of the monolith-based catalysts obtained with the loose powder sintering method and the increase on the apparent density of this catalyst, the direct flue gas conversion to syngas was evaluated for long-term operation. The long-term stability test was carried both on lab- and semi-pilot scales for 100 h of operation with the 5 wt % K promoted loose powder sintered metallic iron-based catalyst. The reactors used for the lab- and semi-pilot scale tests were common fixed-bed reactors without any significant difference apart from their size. For the test on lab-scale, results are presented in FIG. 14. The test was carried at T=700° C., Qₜ=25 mL/min, GHSV=157 h⁻¹, I=5 A, P=10 W under real flue gas conditions (H₂O/CO₂=0.3−0.32).

During the 100 h stability test at lab-scale (FIG. 14), CO₂ conversion varied from 55 to 57% and H₂O conversion ranged from 57 to 60% during the first 88 h of reaction. Selectivity towards syngas products (CO and H₂) was high (>85%) during the whole test. Deactivation signs started to appear around 88 h of time on stream (TOS) and the catalyst conversions dropped to complete deactivation at 105 h. Due to the low H₂O/CO₂ ratio of the flue gas, final H₂/CO ratio of the produced syngas was around 0.45-0.60. The reaction behavior falls within the understanding that the main mechanism of catalyst deactivation is related with the accumulation of iron oxides in the catalyst structure as the conversion of the flue gas progresses.

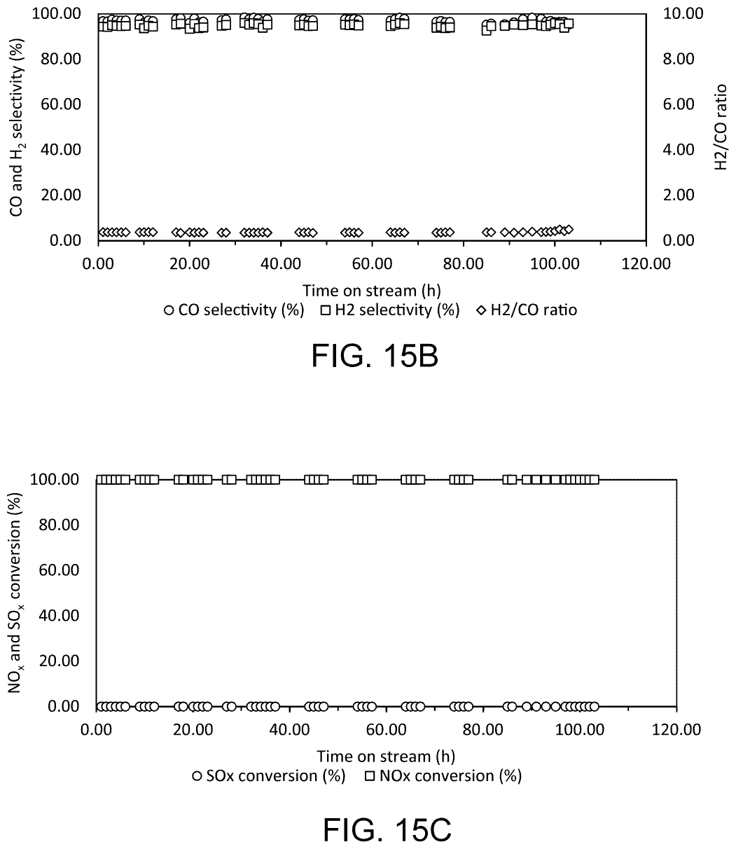

The long-term operation of the direct flue gas conversion to syngas over the monolith-based catalyst was validated at semi-pilot reactor. The long-term stability test on semi-pilot scale was carried for 100 h of operation at T=700° C., Qₜ=560 mL/min, GHSV=157 h⁻¹, without electricity, under real flue gas conditions (H₂O/CO₂=0.30−0.32). Results are presented in FIG. 15.

During the 100 h stability test (FIG. 15), CO₂ conversion varied from 55 to 57% and H₂O conversion ranged from 56 to 58% during the first 91 h of reaction. Selectivity towards syngas products (CO and H₂) was high (>90%) during the whole test. The onset of deactivation happened around 93 h of time on stream (TOS) and the catalyst conversions dropped to complete deactivation at 103 h. Due to the low H₂O/CO₂ ratio of the flue gas, final H₂/CO ratio of the produced syngas was around 0.35-0.45. The test on semi-pilot scale validated the robustness and the predictability of the performance of the sintered Fe catalyst, obtained with the loose powder sintering method, for direct conversion of flue gas into syngas. Parameters and results for both lab scale and semi-pilot scale are summarized in Table 2.

For both stability tests, i.e. the lab and the semi-pilot scales, FIGS. 14C and 15C, the performance for NOₓ conversion and SOₓ conversion was similar. The NOₓ content was completely converted (100% conversion) and the SOₓ content did not change (0% conversion) but it also did not seem to poison the catalyst.

TABLE 2
Parameters and results for both lab scale and semi-pilot scale experiments

| Test Parameters and | | | |
|---|---|---|---|
| Results | Lab scale | | Semi-pilot scale |
| Catalyst | Monolith-based catalysts obtained with the loose powder | | |
| | sintering method | | |
| Reaction temperature (° C.) | | 700 | |
| Qₜ (mL/min) | 25 | | 560 |
| GHSV (h⁻¹) | | 157 | |
| I (A) | 5 | | — |
| P (W) | 10 | | — |
| Flue Gas | | Real | |
| H₂O/CO₂ | | 0.3-0.32 | |
| CO₂ conversion (%) | 55 to 57 | | 55 to 57 |
| H₂O conversion (%) | 57 to 60 | | 56 to 58 |
| CO—H₂ selectivity (%) | >85 | | >90 |
| Beginning of catalyst | 88 | | 93 |
| deactivation (h) | | | |
| Complement catalyst | 105 | | 103 |
| deactivation (h) | | | |
| Final H₂/CO ratio | 0.45-0.60 | | 0.35-0.45 |

### Use of Electricity

As mentioned above, electrical current can be directly applied to the iron-based catalyst, or the catalytic medium including the catalyst, during the reaction for the conversion of flue gas mixtures into syngas. As shown, the use of electricity applied directly to the iron-based catalyst can increase the CO₂ and H₂O conversions and improve the catalyst stability. In addition, the direct contact of the electricity through the iron-based catalyst can allow for the direct participation of the electrons donated by the electrical current to the conversion reaction.

Therefore, the use of electricity applied directly to the iron-based catalyst has two effects. First, the use of electricity can increase CO₂ and H₂O conversion. The increase on CO₂ and H₂O conversion is the result of the creation of hotspots on the iron-based catalyst by Joule effect as a result of the electrical current going through the iron-based catalyst. The creation of hotspots on the catalyst and the resulting increase of CO₂ and H₂O conversion was observed for electrical currents varying in the range of about 5 to about 300 A, and a power ranging from about 10 to about 2200 W. It has been observed that the increase in the electrical power delivered to the iron-based catalyst can lead to an increase on CO₂ and H₂O conversion up to 72% and 80%, respectively (P=2200 W, I=300 A). In addition, these values for CO₂ and H₂O conversion cannot be replicated at higher reaction temperature (up to 950° C.) without the use of electricity, which leads to the conclusion that the hotspots created in the catalytic medium can exceed 950° C.

Second, the use of electricity might lead to the direct participation of the electrons provided by the electrical current to the conversion reaction. In this scenario, the electrons provided by the electrical current can have two effects: i) to activate the reactants (CO₂ and H₂O) reducing them to syngas products (CO and H₂); and/or ii) to be donated to the catalytic medium including the iron-based catalyst and reduce the accumulation of iron oxides, such as FeO, Fe₂O₃, Fe₃O₄, thereby potentially increasing the catalyst stability and its lifespan.

SO₂ Removal from Flue Gas

The presence of secondary combustion products and contaminants, such as SO₂ and NOₓ, on the flue gas may affect the lifetime and the performance of the catalysts used for CO₂ conversion through different mechanisms, such as catalyst poisoning, which leads to deactivation. As specified above, the flue gas used in the example was supplied by a portable dual-fuel generator (model H03651, Firman) operated with gasoline and had an SO₂ concentration around about 60 ppm.

Referring now to FIG. 16, the monolith-based catalyst was investigated for the flue gas desulfurization. XRD analysis of FIG. 16A revealed that right after the sintering step, prior to activation, the catalyst is composed of Fe₂O₃. Iron (II) oxides can react with SO₂ to form iron sulfide (FeS₂), also known as pyrite (Equation 5). As an endothermic reaction, the formation of FeS₂ from SO₂ and Fe₂O₃ is favored at higher temperatures. Moreover, iron oxides can be used for the flue gas desulfurization (Hu, G., Dam-Johansen, K., Wedel, S., & Hansen, J. P. (2006). Decomposition and oxidation of pyrite. Progress in Energy and Combustion Science, 32 (3), 295-314), which means that the deactivated catalyst can be reused at a different part of the process for the SO₂ conversion.

2Fe₂O₃+8SO₂→4FeS₂+11O₂ΔH=−2446 KJ/mol (5)

Catalytic tests were carried out, at a reaction temperature of T=700° C., a flue gas flowrate 50 mL/min, with a GHSV=310 h⁻¹, and a ratio H₂O/CO₂=0.05. FIG. 16B shows the results obtained for the flue gas conversion using sintered Fe₂O₃ (deactivated iron-based catalyst including iron oxides). As no activation step was carried prior to the reaction, no CO₂ and water conversion were observed throughout the test. It is interesting to observe that the SO₂ concentration in the outlet stream was reduced (from about 60 ppm to a concentration below 10 ppm) for the first 2 h of time on stream (TOS), indicating that sintered Fe₂O₃ can at least partially remove SO₂ from the flue gas. On the other hand, at 3 h of TOS, the initial concentration of SO₂ (about 60 ppm) was present in the outlet stream, indicating that the catalyst was no longer active for the desulfurization.

FIG. 17 presents the results of the direct conversion of untreated flue gas over a K-promoted monolith-based catalyst. The reactions were conducted under the same conditions as for the non-promoted monolith-based catalyst, described above, and presented similar results, including a relative high syngas selectivity (above about 56% and about 85% for CO and H₂, respectively, as shown in FIG. 17B). In addition, the alkaline promotion of the catalyst led to a higher CO₂ conversion, between about 50 and about 56% throughout the 5 hour test, as shown in FIG. 17A.

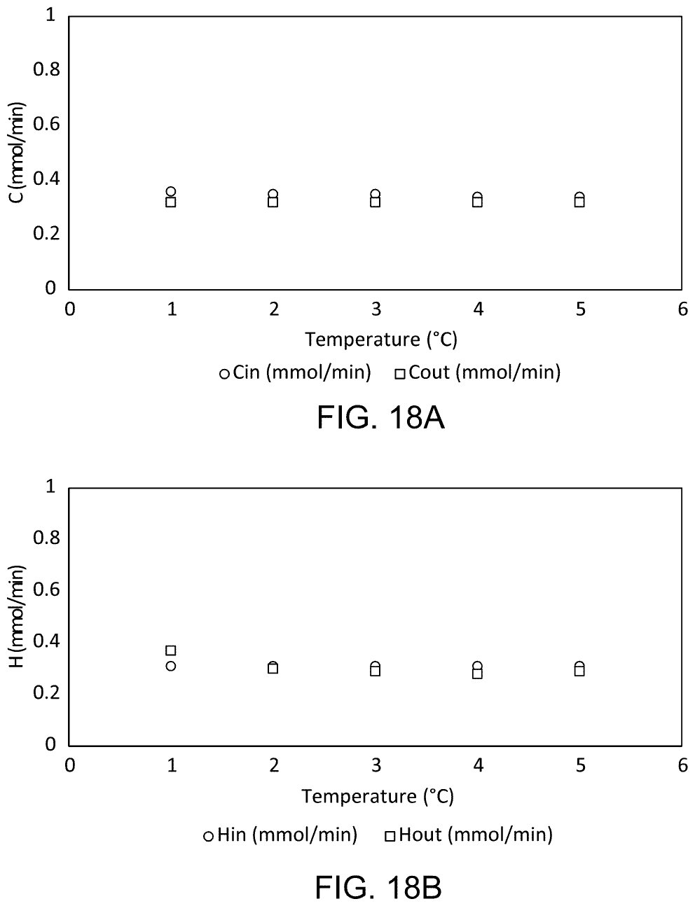

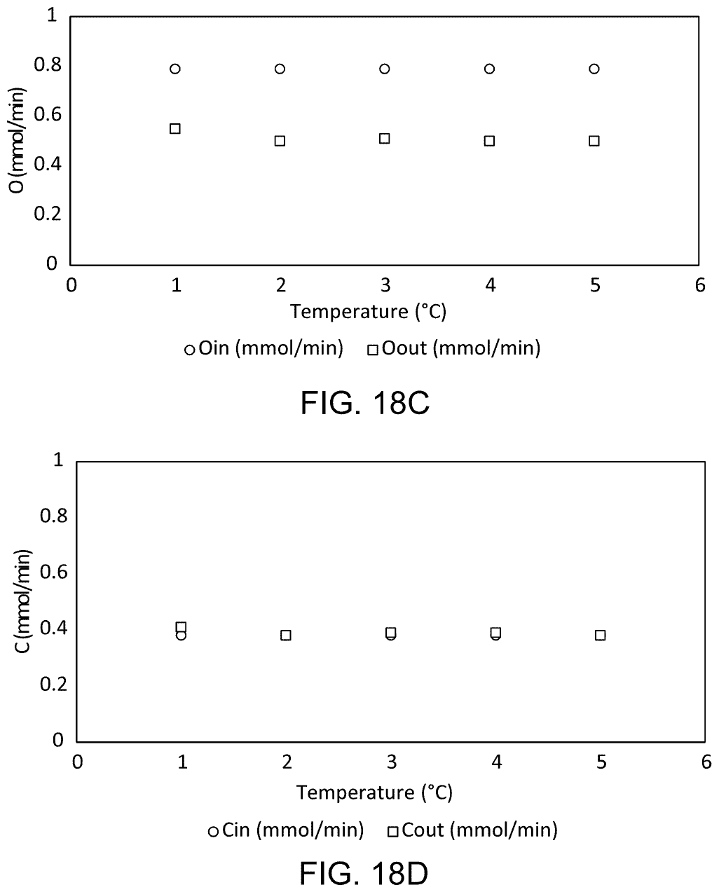

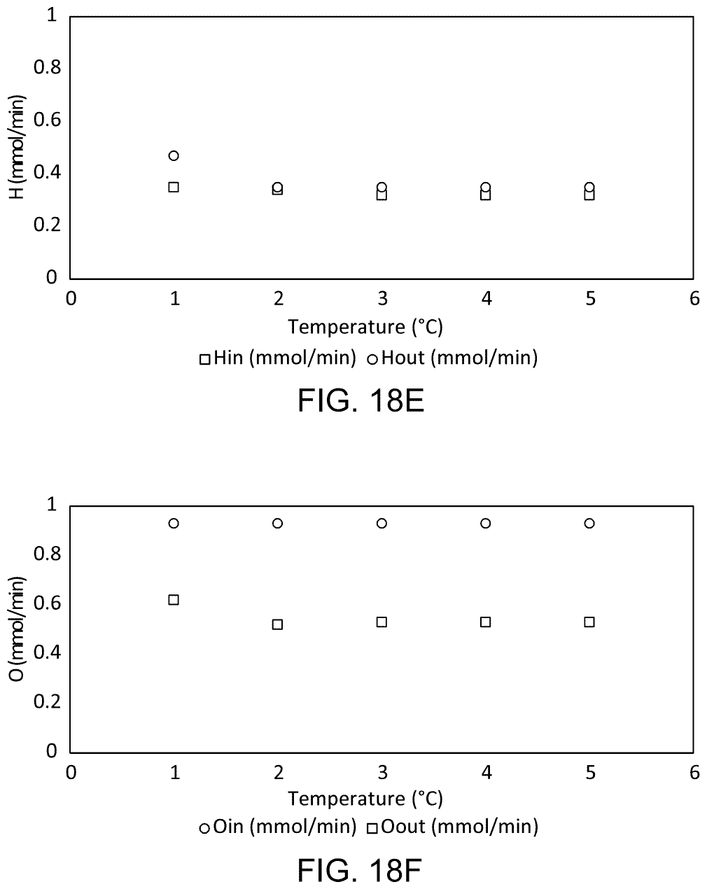

Carbon, hydrogen and oxygen balances for the tests with non-promoted and K-promoted monolith-based catalysts are presented in FIG. 18. Carbon (FIG. 18A,D) and hydrogen (FIG. 18B,E) contents on the inlet and outlet feeds are similar for the 5 h TOS. Small differences on the carbon and hydrogen balances are related to the average composition taken for the flue gas. The oxygen balance (FIG. 18C,F), on the other hand, presents a significant divergence on the oxygen amounts between the inlet and outlet streams. This same behavior has been observed for this catalyst with the simulated flue gas streams and for the steel wool-based catalysts. This indicates that the catalyst is continuously oxidized as the reaction progresses.

### Effect of Pressure

Pressure is a significant operation parameter that can influence both the catalytic activity and the overall process yield. Thermodynamic calculations were carried in order to assess the possible operation limit ranges for the direct flue gas conversion.

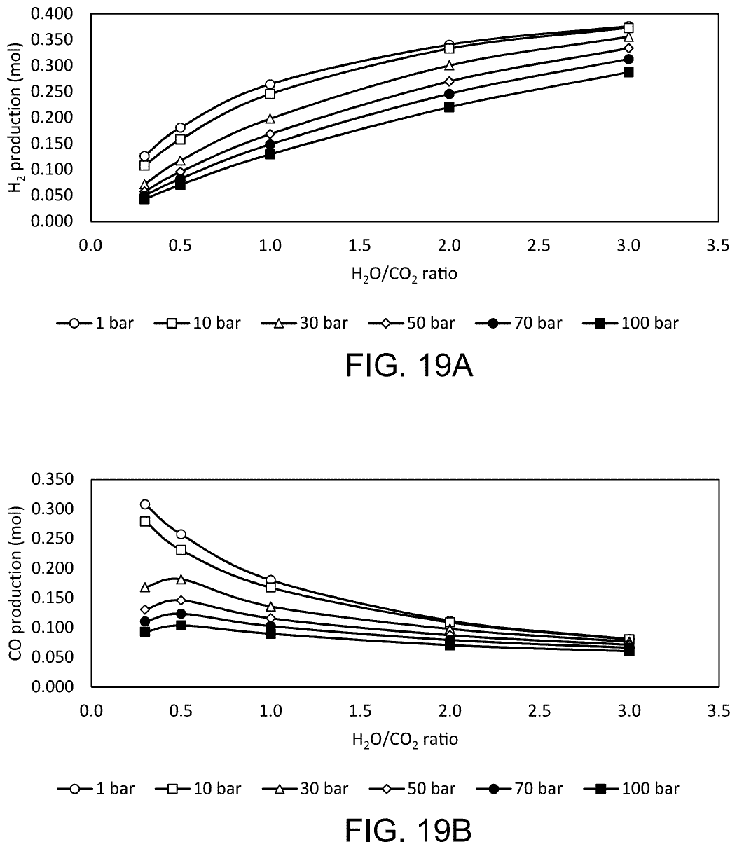

FIG. 19 shows the effect of pressure (1-100 bar) over the production of syngas (H₂ and CO) for different H₂O/CO₂ ratios (from 0.3 to 3.0) in the gaseous feed at a reaction temperature of 700° C. As explained above, the variation of the H₂O/CO₂ ratio of the inlet feed is related to the modulation of the H₂/CO ratio of the produced syngas. FIG. 19 shows that, at a reaction temperature of 700° C., the increase on the H₂O/CO₂ ratio is related to the increase on H₂ production and the decrease on CO production, which increases the H₂/CO ratio of the produced syngas. Therefore, the operation of the direct flue gas conversion process is possible at pressurized conditions up to 100 bar, with the advantage of the production of pressured syngas with adjustable H₂/CO ratio.

### Effect of Temperature

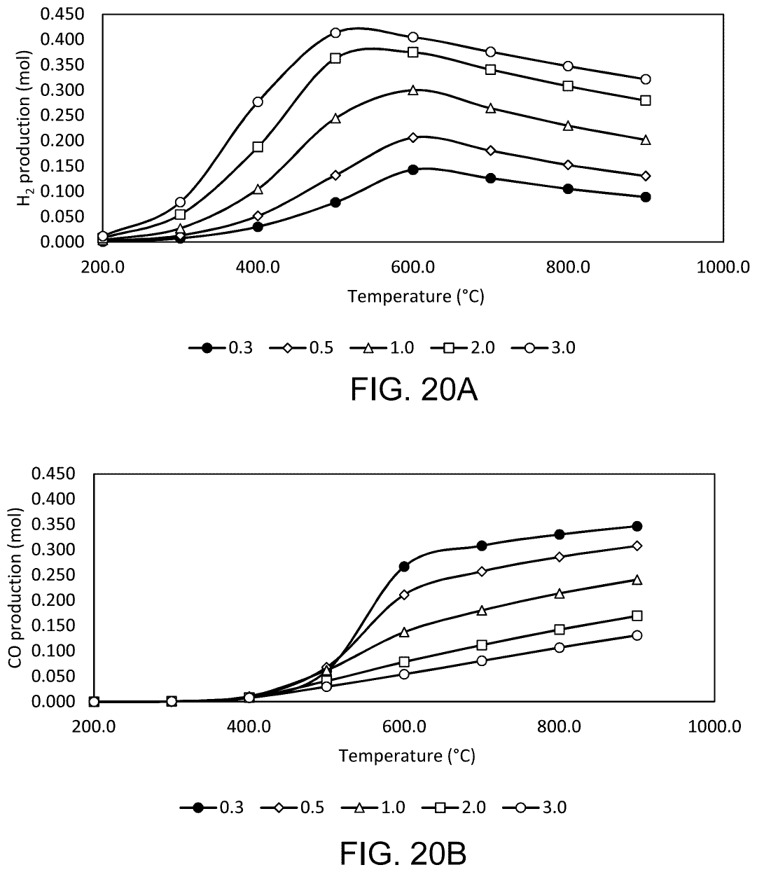

Similarly, the influence of temperature has also been thermodynamically simulated to validate the temperature operation range. FIG. 20 shows the influence of temperature (from 200 to 900° C.) at atmospheric pressure for different H₂O/CO₂ inlet feed ratios (from 0.3 to 3.0). From FIG. 20A, it can be observed that H₂ production is negligible at 200° C. and still very low at 300° C. From FIG. 20B, it can be observed that CO production is negligible at reaction temperature in the range of 200° C.-300° C. and starts low at about 400° C. From the thermodynamic calculations, it can be drawn that the direct flue gas conversion can be operated over the temperature range from about 400° C. to about 900° C., from atmospheric pressure to about 100 bar, and over different H₂O/CO₂ inlet feed ratios (from about 0.3 to about 3.0).

### Syngas Recycling

As explained above, the metallic iron (Fe) is the most active phase of the iron-based catalyst for the direct conversion of either CO₂ and H₂O mixtures, or flue gas, into syngas. As the reaction progresses, the metallic iron is oxidized by the reactants to iron oxides, which are not active for the conversion reaction. As shown in FIGS. 6, 14A, and 15A, catalysts deactivate after a period of time wherein they are contacted by either a CO₂ and H₂O mixture or a flue gas.

The presence of reducing species in the feed composition, such as H₂ and CO, can balance the significant presence of oxidizing agents such as CO₂ and H₂O, and decrease the accumulation of iron oxides (FeO, Fe₂O₃, Fe₃O₄) in the catalyst by reducing them to metallic iron (Fe). The simultaneous reduction of the iron oxides in the catalytic medium can keep the most active phase (i.e. metallic iron) available for a longer period, which extends the lifespan of the catalyst.

The presence of reducing species, such as H₂ and CO, in the feed composition can be achieved by different means. For example, part of the syngas (H₂+CO) produced by the conversion reaction can be recycled back to the feed and act as a reducing agent for the catalyst. Also, the flue gas feed can be combined with alternative streams that can supply a reducing agent for the feed, for example, H₂ stream or a syngas stream from other reforming processes, for instance.

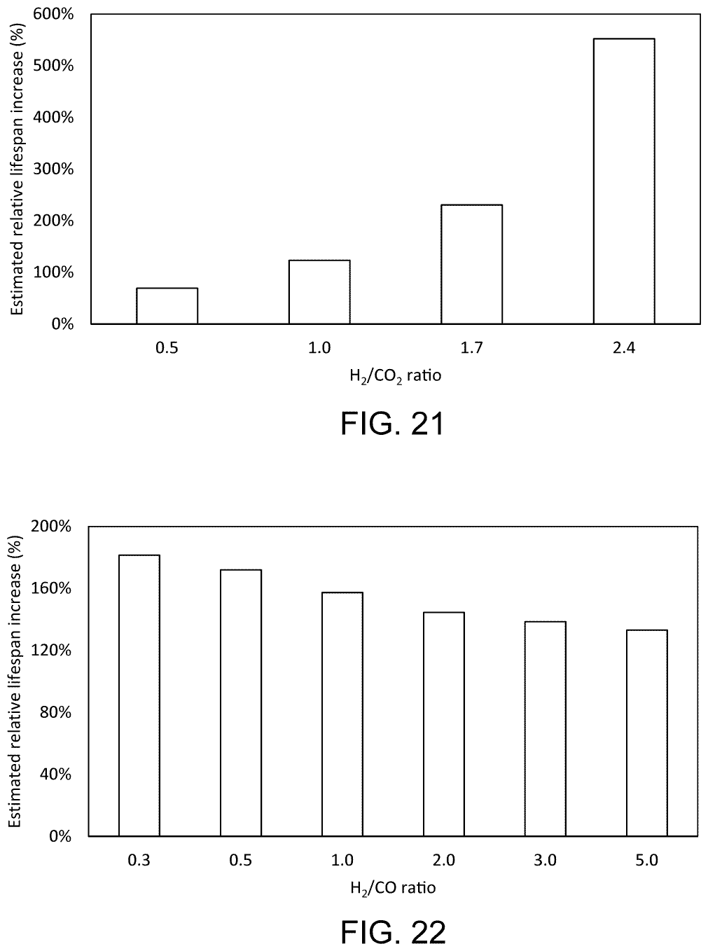

In order to assess the impact of the presence of reducing species in the inlet feed on the catalyst lifespan, thermodynamic simulations were carried out to estimate the increase on the catalyst lifespan for different reducing agent-to-CO₂ ratios. For H₂ as reducing agent, FIG. 21 shows that the relative increase on the catalyst lifespan increases as the H₂/CO₂ ratio increases, i.e. higher the concentration of reducing species in the feed composition, the longer the catalytic activity can last prior to deactivation. The estimated catalyst lifespan increases 70%, when H₂, acting as reducing agent, is injected in the feed stream in a H₂/CO₂ ratio of 0.5. The estimated catalyst lifespan increases to 550% for a H₂/CO₂ ratio of 2.4 in the feed stream.

For syngas (i.e. a mixture of H₂+CO) as a reducing agent, FIG. 22 shows the relative increase on the catalyst lifespan for different H₂/CO ratios for a fixed reducing agent-to-CO₂ ratio of 1.0. As shown in FIG. 22, it is estimated that the catalyst lifespan is longer for lower H₂/CO ratios of the syngas used as a reducing agent. For a syngas with a ratio H₂/CO of 0.3, the estimated increase in the catalyst lifespan is around 180%, while for a syngas with a ratio H₂/CO of 5.0, the estimated increase in the catalyst lifespan is around 130%.

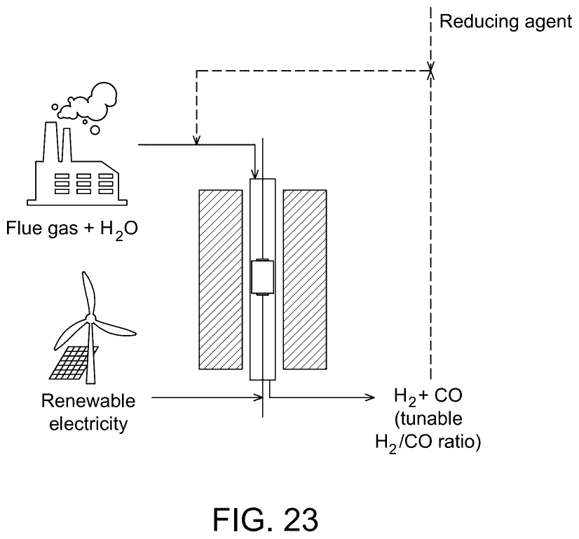

Turning now to FIG. 23, there is shown a schematic flowchart wherein a mixture of flue gas, which can be untreated, is optionally mixed with water vapor (or water in gaseous state) before being introduced into a reactor at a reaction temperature. The ratio flue gas/water vapor can be varied in accordance with the desired product composition and the initial water content of the flue gas. In an embodiment, the ratio H₂O/CO₂ can range between about 0.05 and about 2.0. Inside the reactor, the reactant mixture is contacted with a porous metallic iron-based catalyst, such as the ones described above, and the process, i.e. the conversion reaction, is performed. Optionally, an electric current can be applied to the porous metallic iron-based catalyst during the process. The electricity applied to the catalyst can be characterized by a current, a voltage, and/or a power and can be generated by a renewable energy supply. The reaction products (or the product mixture) can include syngas (a mixture of H₂ and CO), which ratio can be controlled by modifying the water content of the feedstock (or reactant mixture) and the reaction temperature.

As shown in FIG. 23, a reducing agent can be added to the reactants, or the feed stream. The reducing agent can be a portion of the syngas (H₂+CO) produced by the conversion reaction, which is recycled back to the feed, and/or a reducing agent from an alternative supply.

Therefore, there is thus provided a process to produce syngas from CO₂, which is a greenhouse gas, and water, which is abundant in Canada, in an environmentally friendly way. The H₂/CO ratio of the produced syngas is adjustable by modifying the water content of the feedstock and the reaction temperature. The process is carried out using the iron-based catalyst described herein, which is relatively inexpensive, at a relatively low/mild reaction temperature. Furthermore, the use of the iron-based catalyst allows the process to be carried out on an untreated flue gas, thereby eliminating a purification step recovering flue gas from a combustion process and converting the flue gas into a low-carbon fuel.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A H₂O and CO₂ conversion catalyst comprising: a catalyst body comprising at least 50 wt % of iron and having a plurality of gas flow channels extending therethrough thereby defining exposed catalytically-active surfaces comprising metallic iron.

2. The H₂O and CO₂ conversion catalyst of claim 1, wherein the catalyst body comprises a bed of iron-based pieces with the gas flow channels being defined between the iron-based pieces and the iron-based pieces have a size ranging from about 0.01 cm to about 0.7 cm.

3. (canceled)

4. The H₂O and CO₂ conversion catalyst of claim 1, wherein the catalyst body comprises steel wool.

5. The H₂O and CO₂ conversion catalyst of claim 1, wherein the catalyst body comprises a porous metallic iron-based monolith.

6. The H₂O and CO₂ conversion catalyst of claim 1, wherein the catalyst body comprises between about 40 and about 55 wt % of metallic iron.

7. The H₂O and CO₂ conversion catalyst of claim 1 wherein the catalyst body has a volume and at least 25% of the volume is defined by the gas flow channels.

8. The H₂O and CO₂ conversion catalyst of claim 6, wherein the gas flow channels comprise pores defined through the catalyst body and the catalyst body has a pore volume of at least 0.10 cm³/g.

9. The H₂O and CO₂ conversion catalyst of claim 7, wherein the catalyst body has a porosity above 25%.

10. The H₂O and CO₂ conversion catalyst of claim 1, wherein at least 95% of the exposed catalytically-active surfaces comprise iron.

11. (canceled)

12. The H₂O and CO₂ conversion catalyst of claim 1, wherein the catalyst body is a monolith produced by sintering a loose iron-based powder.

13. The H₂O and CO₂ conversion catalyst of claim 1, wherein the catalyst body is a monolith obtained by sintering a coating comprising iron, the coating being deposited onto a degradable porous 3D structure.

14. The H₂O and CO₂ conversion catalyst of claim 1, further comprising at least one catalyst promoter being exposed superficially on the catalyst body, and wherein the at least one catalyst promoter is selected from the group consisting of potassium (K), cobalt (Co), CaO, copper (Cu), nickel (Ni), CeO₂, and mixtures thereof.

15.-37. (canceled)

38. A process for converting a gas mixture into a low-carbon fuel, the process comprising:
providing a feed gas mixture including CO₂ and H₂O; and
contacting the feed gas mixture with the CO₂ and H₂O conversion catalyst as defined in claim 1 at a reaction temperature ranging between about 400° C. and about 950° C. to produce a product mixture including H₂ and CO.

39. The process of claim 38, wherein the feed gas mixture comprises flue gas and the feed gas mixture comprises untreated flue gas including at least one of O₂, N₂, CO, NOₓ, SOₓ, particulate matter, and volatile organic compounds (VOC).

40. (canceled)

41. The process of claim 39, wherein the untreated flue gas comprises at least 50 ppm of a total content of NOₓ, SOₓ, particulate matter, and volatile organic compounds (VOC).

42. The process of claim 38, further comprising applying an electrical current to the H₂O and CO₂ conversion catalyst when contacted by the feed gas mixture and, wherein the electrical current is between about 5 Å and about 300 A and an electrical power is between about 10 W and 2200 W.

43. (canceled)

44. The process of claim 38, wherein the feed gas mixture is contacted with the H₂O and CO₂ conversion catalyst at atmospheric pressure or in pressurized conditions up to 100 bar.

45. (canceled)

46. The process of claim 38, wherein the product mixture has a ratio H₂/CO between about 0 and about 3.0 and the feed gas mixture has a ratio H₂O/CO₂ ranging from about 0.05 to about 3.0.

47. (canceled)

48. (canceled)

49. The process of claim 38, wherein the feed gas mixture comprises a reducing gas and the reducing gas comprises a portion of the product mixture.

50.-71. (canceled)

72. A continuous reactor comprising:
a housing defining a reaction chamber configured to contain the CO₂ and H₂O conversion catalyst as defined in claim 1, the housing having a feed gas inlet and a reaction product outlet and being configured to have a continuous flow gas flowing in the reaction chamber between the feed gas inlet and the reaction product outlet.
